(19) United States
(12) Patent Application Publication
(10) Pub. No.: US 2013/0268246 A1
(43) Pub. Date: Oct. 10, 2013

(54) METHOD, SYSTEM, AND APPARATUS FOR AIMING LED LIGHTING

(71) Applicant: MUSCO CORPORATION, Oskaloosa, IA (US)

(72) Inventor: Myron Gordin, Oskaloosa, IA (US)

(73) Assignee: MUSCO CORPORATION, Oskaloosa, IA (US)

(21) Appl. No.: 13/790,477

(22) Filed: Mar. 8, 2013

Related U.S. Application Data
(60) Provisional application No. 61/619,995, filed on Apr. 4, 2012.

(51) Int. Cl. G06F 17/50; F21V 21/14

(52) U.S. Cl. CPC G06F 17/50; F21V 21/14
USPC 703/1; 362/249.09

(57) ABSTRACT

A system and method for assisting in aiming, designing, and demonstrating a lighting scheme for a target space. Aiming points in the actual physical space can be described either with descriptive terms, relative to a coordinate system, or otherwise. Those descriptions can be stored or recorded. The can then be recalled at another time to supply information relevant to aiming lighting fixtures, designing lighting systems for that target space, or demonstrating (either real or simulated) illumination of the target area. In one aspect, the foregoing method can be assisted with an apparatus or system which mounts an aiming module with a fixture or lighting modules or sources on a fixture or both. The aiming module can also project or guide a user as to superposing the light output distribution pattern of a fixture or light source to the target to help locate parts of the beam in the target.

### CROSS-REFERENCE TO RELATED APPLICATIONS

This application claims priority under 35 U.S.C. §119 to provisional application Ser. No. 61/619,995 filed Apr. 4, 2012, herein incorporated by reference in its entirety.

### BACKGROUND OF INVENTION

The present invention generally relates to the field of lighting. Embodiments of the invention have particular application to LED and/or other solid state lighting sources, but may be applicable to all types of lighting.

### BACKGROUND

As explained below, a number of situations exist where lighting fixtures for illuminating an area or target, must be designed, demonstrated, and/or installed. Configurations could range from relatively simple and small scale to relatively complex and/or large scale (plural fixtures, elevated to substantial heights, with comprehensive lighting coordination). Just as the physics of light are esoteric and subtle, so are the needs and demands associated with efficient and effective design, demonstration, and installation of lighting systems. There is a vast number of available options in lighting (e.g. types of light sources, types of optics, color, color temperature, intensity, efficiency, etc.) and a wide variety of potential applications of illumination schemes for different applications; this presents complexities to lighting designers, manufacturers and installers.

### Lighting Schemes

Lighting schemes (i.e. light, typically from artificial sources applied according to a plan to a target area) attempt to create an ambient effect based on the interaction of artificial lighting with a target area, as perceived by viewers. Examples of effects include:
a. sufficient (but not excess) lighting for a task or activity, such as walking, driving, reading, playing sports, etc.;
b. visual perceptions which convey mood, enhance or beautify an area or object, or emphasize or contrast one area or object compared to another;
c. displays of light which in themselves have aesthetic appeal;
d. avoiding illuminating or over-illuminating certain objects or areas which are in, near to, or outside the target area;
e. avoiding or reducing uplighting (light above horizontal, directed skyward);
f. avoiding subjective negative effects such as harshness or glare; and
g. other desired effects.

Lighting schemes may be specified, in a first case, according to quantitative and qualitative values, such as lumens at given locations, color temperature, incident angle, etc., or in a second case, the scheme is more subjective (i.e. something like “a generally bright, warm, and cheerful effect, highlighting the architectural features of the area and providing good lighting for night time walking”). Both cases typically require considerable expertise from the lighting designer to provide lighting matching the expectations of the customer. In the second case particularly, the customer typically does not have sufficient knowledge of lighting to be able to provide measurable specifications. The result may be an inability to communicate what is desired to the designer such that the customer can only say “I'll know it when I see it.”

### Lighting Design

Lighting design is the art and science of creating a scheme of lighting which will create the desired effect. Typically a lighting designer attempts to create the scheme of lighting based on a description of the desired effect provided by someone concerned with a target area (“the customer”). The designer then specifies physical components of a lighting system. Specifications can include type (HID, incandescent, LED, etc.), number, size, and placement of light sources, as well as other factors such as varying basic lighting types, using lenses, reflectors, deflectors, etc., and changing the color, color temperature, intensity, and overall light output. Locations for lighting sources will be specified, including positioning relative to landmarks on the site and aiming coordinates relative to mounting location and/or the target area or landmarks. From these specifications, a specific group of components comprising a lighting system will be collected and physically installed in a location. Care will be taken during and following installation to adjust the lighting system in order to meet the original description and specifications.

After a lighting system has been installed, the customer will evaluate the lighting system with reference to their original request.

If, as in the first case above, the request was rather detailed and specific, usually the system as designed will meet the expectations of the customer. However during design or installation it may become apparent that lighting sources that exactly meet the desired specifications may not be available. Likewise it may become apparent that ambient conditions may be actually different than described because of error or because of a physical change in the target area. Thus considerable effort may be spent by the designer and installer to adjust the aim of the lighting sources in order to meet specifications. These adjustments must be made during night time hours, which can be quite inconvenient, since sunlight obscures the effect of night lighting.

In the second, less specific, case above, in addition to the same problems of design and installation, the subjectivity of the specification can cause the customer not to be satisfied with the result. Although the system of lighting may perfectly match the specifications from the designer, the effect of the lighting as perceived by the customer may not be what was originally desired. The customer having previously said “I'll know it when I see it” now “sees it” and can only say “and this isn't what I wanted.”

### Lighting Demonstration

Another concern in the field of lighting is the difficulty of providing a demonstration of proposed lighting. Many more lighting projects might be undertaken if there were ways to show a potential client a realistic simulation or demonstration. For instance, if a live demonstration is attempted, much effort is often spent by a lighting supplier at night, after normal working hours before the lights can even be shown. Lights must be set up and manually aimed, then reconfigured by trial and error to demonstrate live to a customer different lighting schemes. This is difficult, time consuming, and labor intensive.

Thus, there is need in the field of lighting for improvements (1) in the ability to create lighting schemes which accurately represent what the customer desires and (2) in the ability to adjust aim of lighting systems.

### SUMMARY OF INVENTION

The invention envisions various methods, systems and apparatuses which provide these and other improvements.

It is therefore a principle object, feature, advantage, or aspect of the present invention to improve over the state of the art and/or address problems, issues, or deficiencies in the art.

One embodiment according to aspects of the invention uses point-by-point analysis to provide aiming points for fixtures by identifying a reference as well as lighting target locations and lighting installation locations with reference to the aiming point or other fixed reference points. One result of this analysis is the ability to identify points on a target area such as a field, lot, or building, which can be used as targets for aiming fixtures. This can be accomplished using traditional surveying type methods, GPS location, cameras, range finders, etc.

Other embodiments according to aspects of the invention use multiple lasers to indicate the approximate extent of the light applied from a given lighting fixture to a given area, allowing estimation of light levels at a given isocandela contour (for instance at the 50% beam intensity curve) and approximate placement of lighting fixtures even during daylight hours. The lasers may be installed on lighting fixtures to provide direct aiming, or may be mounted such that their aiming coordinates may be transferred to light fixtures. The patterns from the laser arrays can indicate proper aiming at a desired overlap level at a given isocandela curve from the fixture. Additionally, for applications where avoiding unwanted light is important, lasers may be configured to indicate either zero light intensity, as might be used with a so-called “cutoff” fixture, or at a 10% intensity isocandela curve to ensure that light beyond a target area is limited to an acceptable level.

Other embodiments according to aspects of the invention uses an apparatus such as a scope or camera which is aligned with a light source (see, e.g., FIG. 5A reference numeral 40) to provide a view of the area which would be illuminated by a given isocandela curve from the fixture. This view could be used by itself for aligning a fixture, or it could be optically or electronically aligned with an overall view of the target area such as an image from a camera located at a known reference point.

In conjunction with the above embodiments, or with the use of separately obtained images of a target area, in other embodiments according to aspects of the invention, software or hardware means could be employed to simulate many factors of a proposed illumination scheme for the target area, thereby providing a useful simulation of proposed lighting as well as technical specifications for fixtures and aiming parameters. Also envisioned are embodiments according to aspects of the invention which use other aspects of the invention to provide or facilitate provision of pricing quotations, placement diagrams, and installation plans.

Other embodiments facilitate demonstrating lighting techniques and applications by reducing the amount of time spent at night in set up and trial and error, thereby improving the ability to show features and options of proposed lighting systems.

These and other objects, features, advantages, or aspects of the present invention will become more apparent with reference to the accompanying specification.

### BRIEF DESCRIPTION OF THE DRAWINGS

From time-to-time in this description reference will be taken to the drawings which are identified by figure number and are summarized below.

FIG. 1 illustrates a laser array according to aspects of the invention.

FIGS. 2A-G illustrate a lighting source, applications, and embodiments according to aspects of the invention using an individual light source.

FIGS. 3A-E illustrates a lighting source, applications, and embodiments according to aspects of the invention using two or more individual light sources installed in one or more fixtures.

FIGS. 4A and B illustrate an alignment method and embodiments according to aspects of the invention using a fiberoptic viewing apparatus.

FIGS. 5A-B illustrate an alignment method and embodiments according to aspects of the invention using a camera viewing apparatus.

FIGS. 6A-E illustrate an alignment method and embodiments according to aspects of the invention using a camera viewing apparatus and associated display method.

FIGS. 7A-B illustrates an alignment method and embodiments according to aspects of the invention using a central reference point to create separate aiming points.

### DETAILED DESCRIPTION OF EXEMPLARY EMBODIMENTS

In the following description, for the purposes of explanation, numerous specific details are set forth in order to provide a thorough understanding of embodiments of the present invention. It will be apparent, however, to one skilled in the art that variations to the embodiments specifically discussed herein are possible.

### Overview

Lighting fixtures often have a projected beam which varies in intensity from the highest intensity (100%) at a central point along the central axis to a point at some angle where the light is diminished to very little usefulness (typically defined as 10% of the central value). At some angle in-between the central point and the 10% extent, the beam will have an intensity of 50% of the central value. When this beam is projected normal to a surface, the points on the surface having that 50% intensity may be described as the “50% isocandela curve” (or “50% curve”). When two lights are aimed such the 50% curve from each light source are partially intersecting, the effect will be illumination that is close to 100% of the value of one fixture across most of the area which is illuminated simultaneously by both lights. This becomes a principle for aiming lights which generally provides good results. Note that these points are determined using a light meter, but are not obvious to the casual observer. This contributes to the impression of even lighting in a given area, but can make precise aiming difficult.

In general, the present invention relates to methods, apparatus and systems that can be beneficial to the design, demonstration and/or installation of lighting systems. As described in the Background of Invention, conventional practice is to gather information from a customer about what the illumination should be like, design the system based on lighting design knowledge and skills, and either attempt to demonstrate it with simulation before installation or install it. Some of the difficulties with conventional processes have been discussed above. Some of the subtleties include but are not limited to the following. Any such lighting systems have significant capital costs. Supporting structures to elevate the fixtures, in-ground foundations, multiple fixtures and light sources, wiring and other electrical components are required. Thus, installation according to a design which does not result in approval by the customer risks loss to the installer if equipment must be changed. Just the loss regarding having to adjust the installed equipment can be significant. Conversely, if any installer tries to rig up a simulation of a lighting design before installation of it permanently, it is difficult to simulate, especially if the plan calls for elevated fixtures and a lot of them. It is difficult too, on a temporary basis for demonstration, to both have the right equipment and produce an accurate simulation. Still further, there is room for improvement on the front end—namely in designing the lighting plan. There are a number of computerized lighting design programs some of which are commercially available, that let lighting designers input design criteria and help create such things as placement and aiming of fixtures based on the input criteria and parameters like (light levels, color, etc.). However, there are subtle limitations and issues with such conventional programming and processes. For example, most such programs require a high level of lighting knowledge and design expertise to operate and evaluate. Another example is that existing programming does not allow easily understandable simulations or demonstrations of selected designs to the designer or customers, installers, or other interested parties. Still further, there is a need for better tools to assist in such things as not only demonstrating a proposed lighting design in an efficient and easy manner but also to efficiently set up either demonstration or installation of a design or assist in easy and quick adjust of either a demonstration, preliminary, or final installed lighting system. There is a need for improved lighting design tools.

For a better understanding of the invention, specific embodiments of aspects of the invention will now be set forth. It is to be understood that these specific embodiments are for the purposes of illustrating some of the different forms the invention can take and not by way of limitation to the invention.

### First Embodiment

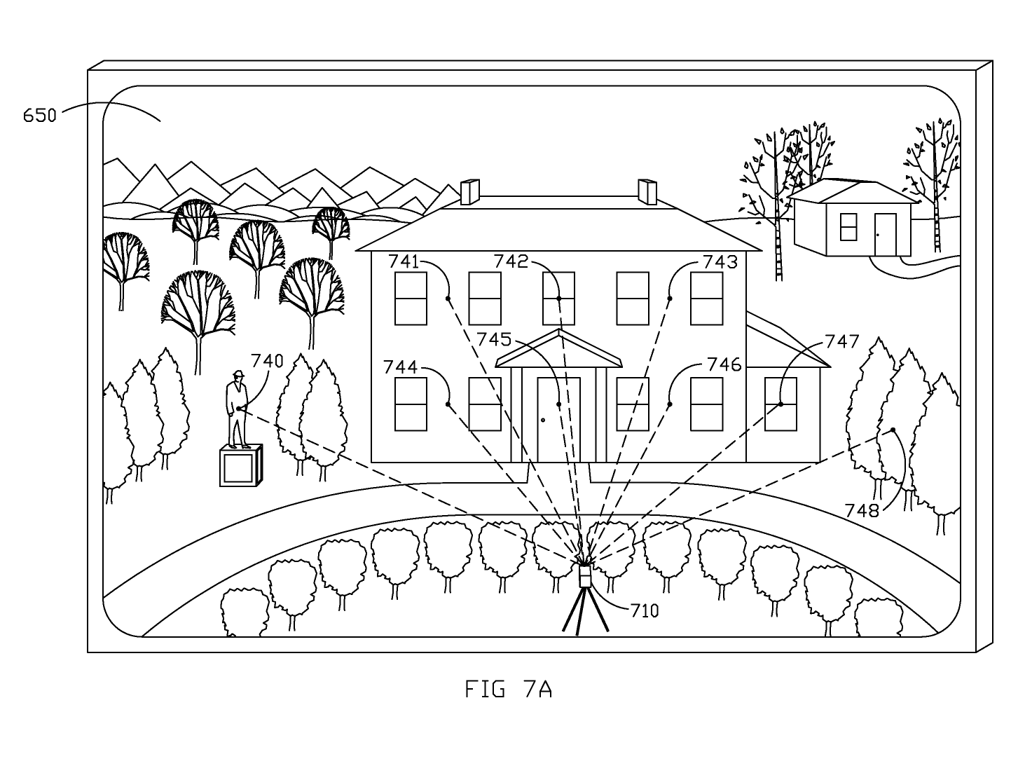

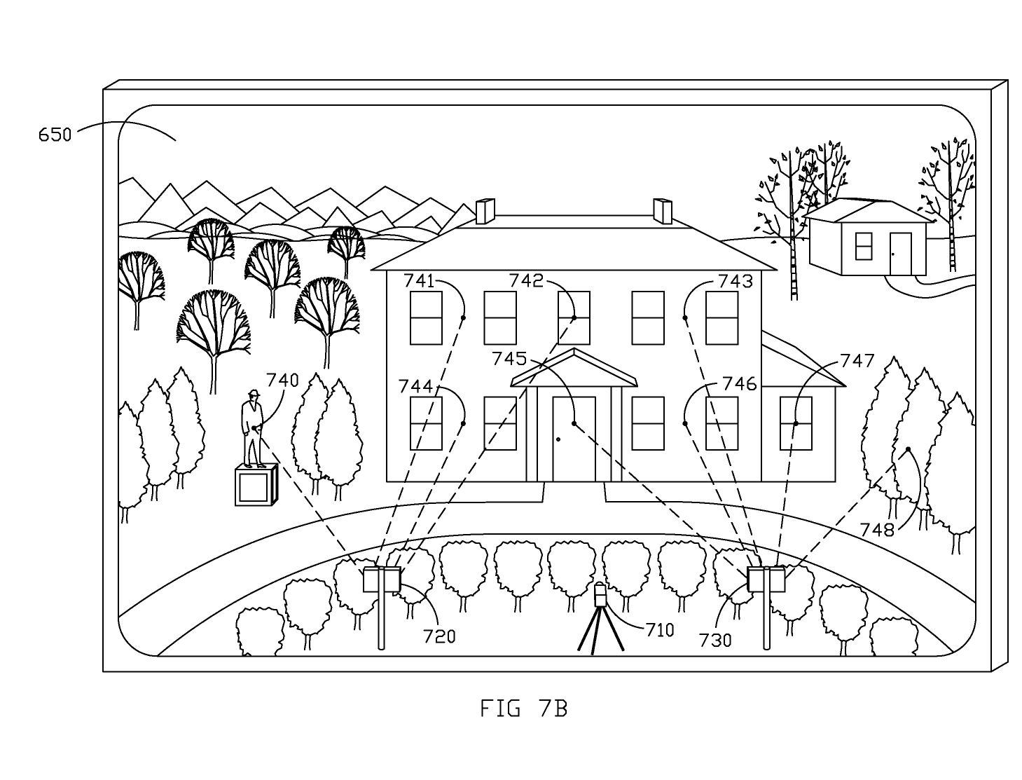

One embodiment according to aspects of the invention uses point-by-point analysis to provide aiming points for fixtures. The result of this analysis is the ability to identify points on a target area such as a field, lot, or building, which can be used as targets for aiming fixtures. Frequent reference should be taken to FIGS. 7A and B. This example, illustrated through FIGS. 7A and B, pertains to an illumination task for buildings and other objects on a property. The FIGS. 7A and B show an image that could be displayed on screen 650 of, for example, a digital camera, or some display associated with a computer (laptop, PDA, smart phone, desktop, etc.). However, in this example, the methodology is applied to the physical property in the following way.

An efficient way to set up a demonstration of lighting or install lighting for illuminating the house, the trees to the right of the house, and the statue to the left of the house, would be to establish in real space aiming points on the targets (house, trees, statue) from a fixed reference location (710). These points 740-748, from known reference position 710 can be found through any of a number of known ways to define the relationship between points 740-748 and the reference location 710. Examples are Cartesian, spherical, or polar coordinate systems for three-dimensions. Other relationships that would define the same are possible. A number of aiming points can be selected according to need or desire. Additional points or measurements could be included, for example, to define a perimeter of one of the objects or the entire area of the target.

These measurements defining known physical space relationships to the reference 710 can be stored or recorded by any number of means. One convenient way would be with some sort of digital device that allows input. Another way would be use of commercially available equipment such as used in surveying which has integrated with it the capacity to store similar data. Once this is captured and recorded, a physical space framework is defined. One example of information that could be recorded would be a physical description of the location of each point 740-748. For example point 740 could be characterized in the recorded data as the middle belt line of the statue to the left of the house. Point 748 could be defined as the middle of the middle trees to the right of the house. Point 741 could be defined as midpoint between middles of left-most two windows at top of house.

Such a recorded characterization of actual physical space of the target can be preserved and then recalled for a number of beneficial uses. One would be for the lighting designer. Reference points to the known reference 710 could be used as aiming points for lighting fixtures or in some way correlation points to aiming for lighting fixtures. As indicated in FIG. 7B, the position of the fixtures 720 and 730, there shown elevated on poles and away from the reference point 710, is not the same as reference point 710. But the lighting designer could use those aiming points in the design plan and correlate the lighting fixtures thereto. Another example would be a demonstration of a lighting system. Having the pre-known aiming points 740-748 could allow quick setup of a temporary demonstration of lighting allowing the person setting up the demonstration to have pre-known, well identifiable physical aiming points. The quick and easy aiming could be accomplished by estimating with tilt and pan orientation of each fixture to its aiming point. Alternatively, more precise ways could be used such as using some sort of a device as a laser or surveying matching to provide the correct vector to the aiming point.

In any event, the system of FIGS. 7A and 7B has several benefits over conventional processes. One benefit of the system of FIGS. 7A and 7B is improving accuracy and reproducibility of demonstrations. Since precise aiming points are identified, lighting can be aimed without guesswork. Aiming points are not dependent on an operator's memory of a site, and are normally preserved regardless of time interval between site measurement, demonstration, and final installation. Further, if modifications to the installation are desired, any amount of the original lighting installation might be removed and replaced without requiring a repeat of the initial site measurement. Thus less care might be needed in removing the lighting installed according to the system of FIGS. 7A and 7B, since aiming parameters are easily reproducible.

Another benefit of the system of FIGS. 7A and 7B is making it possible to simulate proposed lighting for a site while at a location distant from the site. Lighting demonstrations via display can show views of proposed lighting, including variations in intensity, balance, color/color temperature, etc., which can be reproduced with a high degree of fidelity in the actual installation.

Another benefit of said system relating to demonstration is the ease of performing demonstrations via simulation remotely from both the installation site and from the site performing the analysis and demonstration of the lighting installation. For instance, a customer headquartered in New York might be interested in lighting a location in Texas. After a technician has visited the site in Texas, the information about the site may be transmitted electronically to a site in Iowa where the analysis is performed. The display of the demonstration may be transmitted electronically to the customer in New York. Changes requested from New York could be instantly shown from the remote location. Or local and distance demonstrations could be combined.

The remote demonstrations could be accomplished through commercially available methods such as internet, dedicated phone lines, video phone service, etc.

Another benefit of said system is providing the ability to record site information in a standardized format. Even if limited or no use is made of the above features, the description of the site and its features would provide information that could be useful for conventional lighting design.

Another benefit of said system is the ability to provide information in order to quickly set up temporary or permanent lighting installations. A technician might visit a site, design a lighting system, install and aim the system all during daylight hours. Then a customer could be shown a system on that same night. The system could be further adjusted or could be used as the permanent installation or the model for a permanent installation. This is a significant improvement in timeliness and ability to reliably demonstrate a proposed lighting system, and provides potential for reduction in cost for lighting design.

Further discussion of the embodiment of FIGS. 7A and 7B follows.

As envisioned, a reference point at some distance from the target area is identified as to geographical location and elevation. This identification can be absolute, for example based on GPS information, or relative to a landmark at the site, such as by specifying a distance and angle from a particular landmark, or by specifying a distance from multiple landmarks. The reference point location is correlated to the location of the target area and dimensional data is recorded for the site. This data may include measurements of distance, angle, and elevation relative to landmark(s) and relative to the target area. Optical instruments such as rangefinders, transits, theodolites, etc. may be used to find position information. A digital camera or other recording device may be used to capture sight information. In one embodiment, a laser transit 710, FIG. 7A, is used both to record distance and angular position information as well as to provide a visual “laser dot” aiming point on the target area.

Information recorded relative to the reference point, as well as visual observations on-site, is used to create a point-by-point aiming plan. This plan specifies individual locations 740-748, FIG. 7A, on the target area as aiming points for individual fixtures. From this information, a lighting plan is devised for the site which specifies fixture locations 720 and 730 (FIG. 7B) and also type and number of fixtures. Then for demonstration or permanent installation, the fixtures are installed and aimed at the specific locations on the target area.

This aiming may be accomplished by using the existing aiming device (for example the laser transit) to recreate the aiming points on the target area. For example, visible laser dots are projected onto the target area. Then, using aiming methods previously discussed, the central axes of the fixtures are aimed to the laser dots as illustrated in FIG. 7B.

These methods may be implemented also, for example, using a camera to record a digital photo of a target area. Specific features of the target area may serve, by themselves, or in combination with measuring and analysis methods, to provide the aiming points. In other words, something equivalent to saying “the upper right corner of the first window from the left on the top” may be a sufficiently accurate description for the aiming methods previously described, such as using a laser beam which is coaxial with the central axis of the fixture.

Additionally, since several factors relating to the surface finish characteristics of the target area will have significant influence on the amount of light required to be supplied to the surface in order to achieve a desired visual effect, the point-by-point analysis may also be combined with a visual evaluation and/or luminance readings in order to make adjustments to calculations for the lighting plan. In other words, if the area surrounding point 747, FIG. 7A is painted a significantly darker color than the other areas on the building, possibly twice as much light will be needed to be provided to that area in order to create the desired visual effect. These observations or calculations may be recorded informally, included in manual calculations, or incorporated into automated calculations or design software.

### Second Embodiment

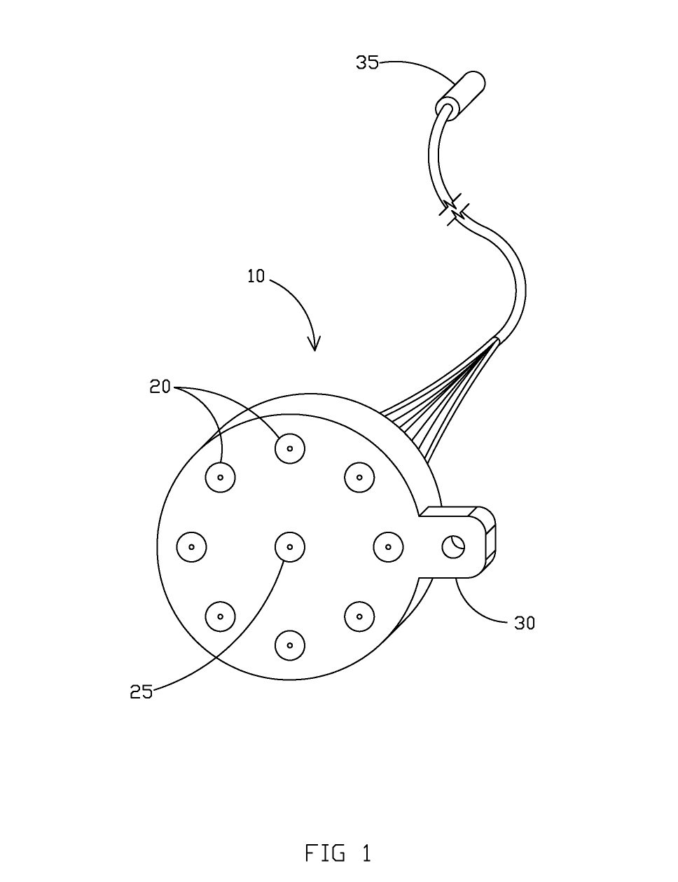

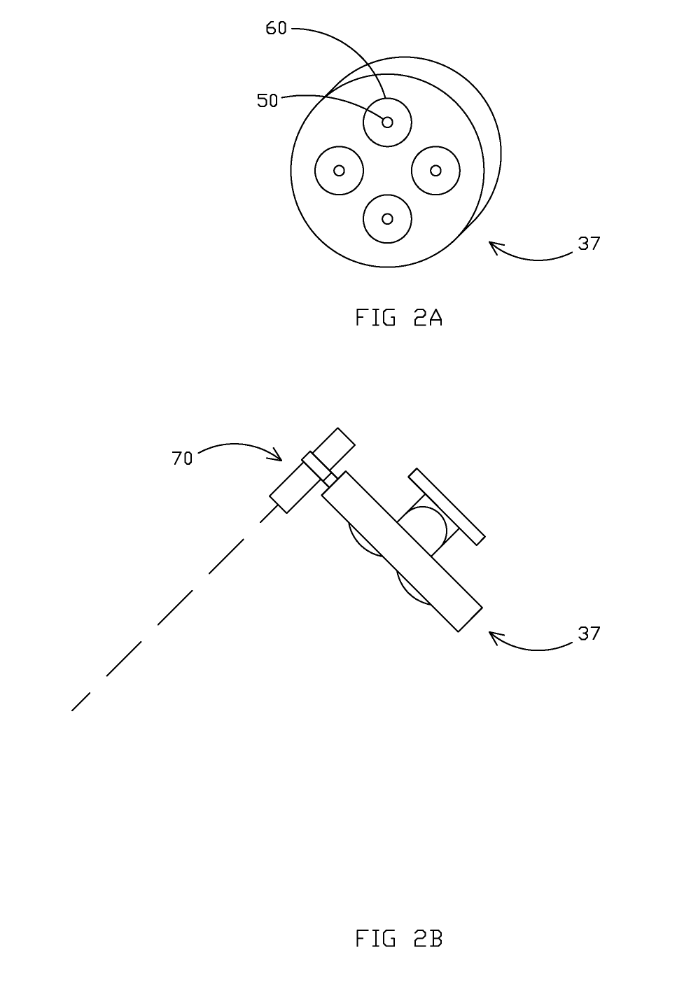

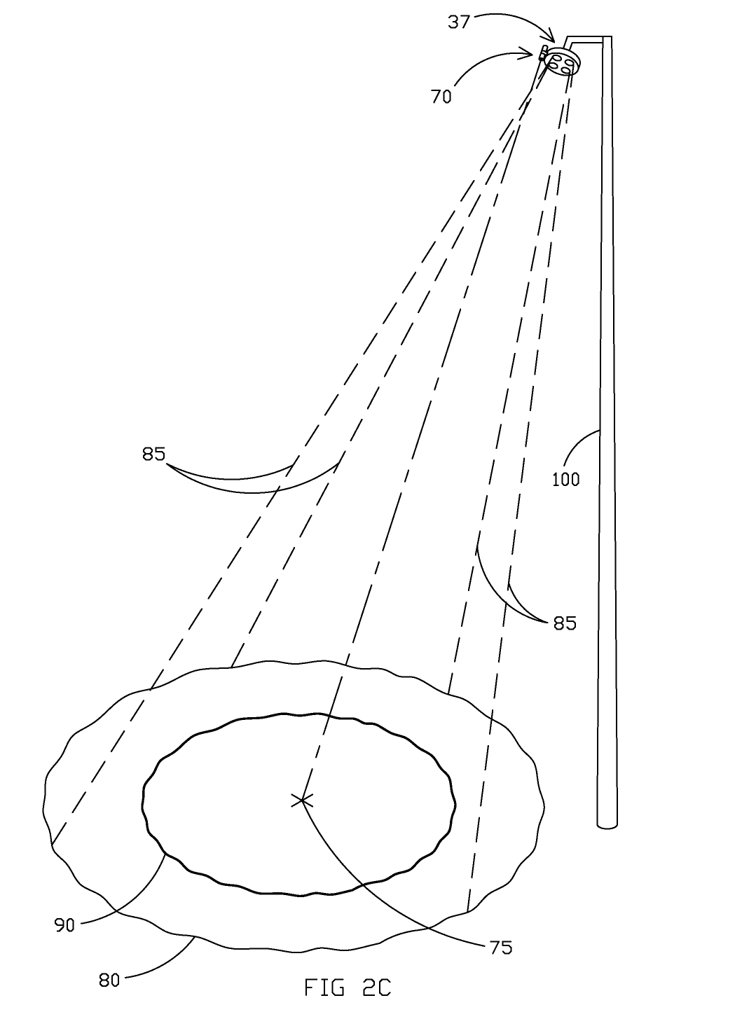

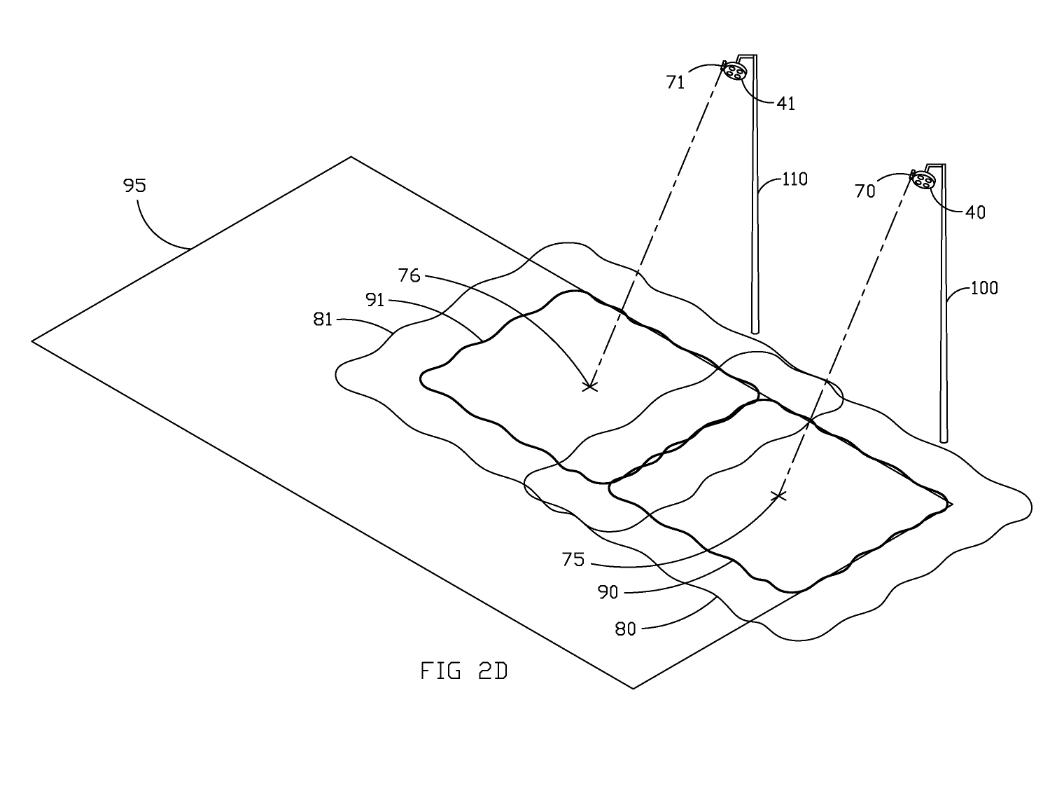

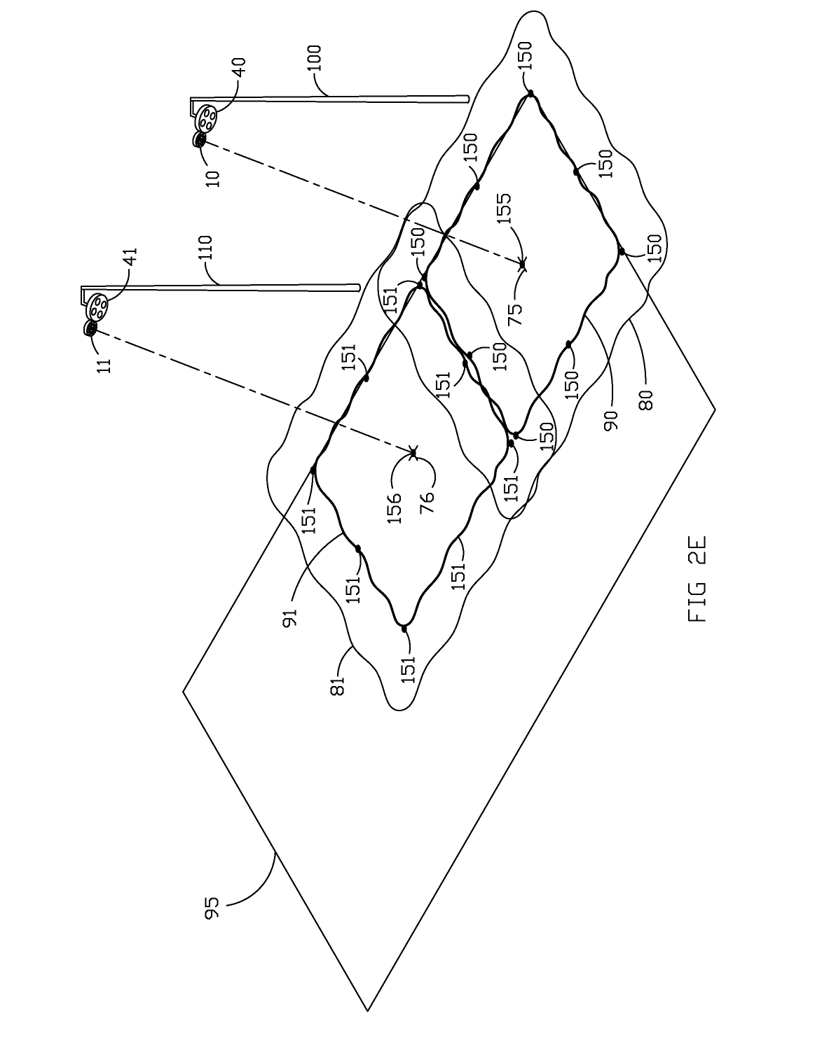

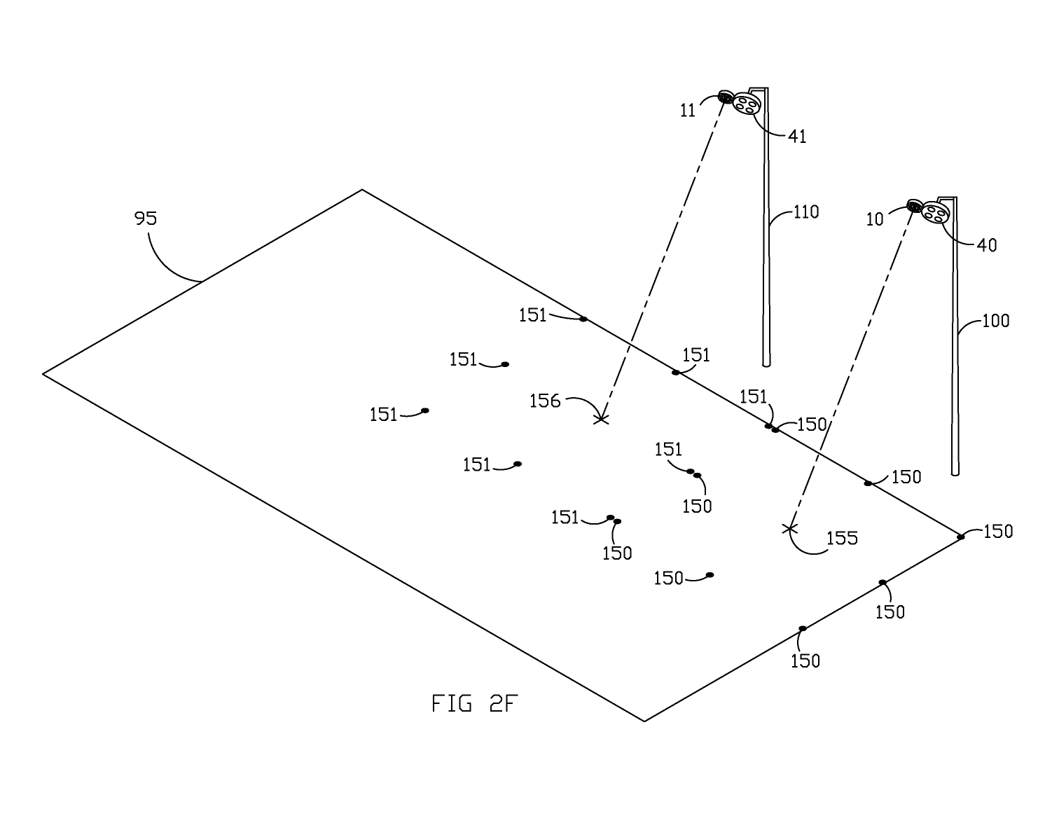

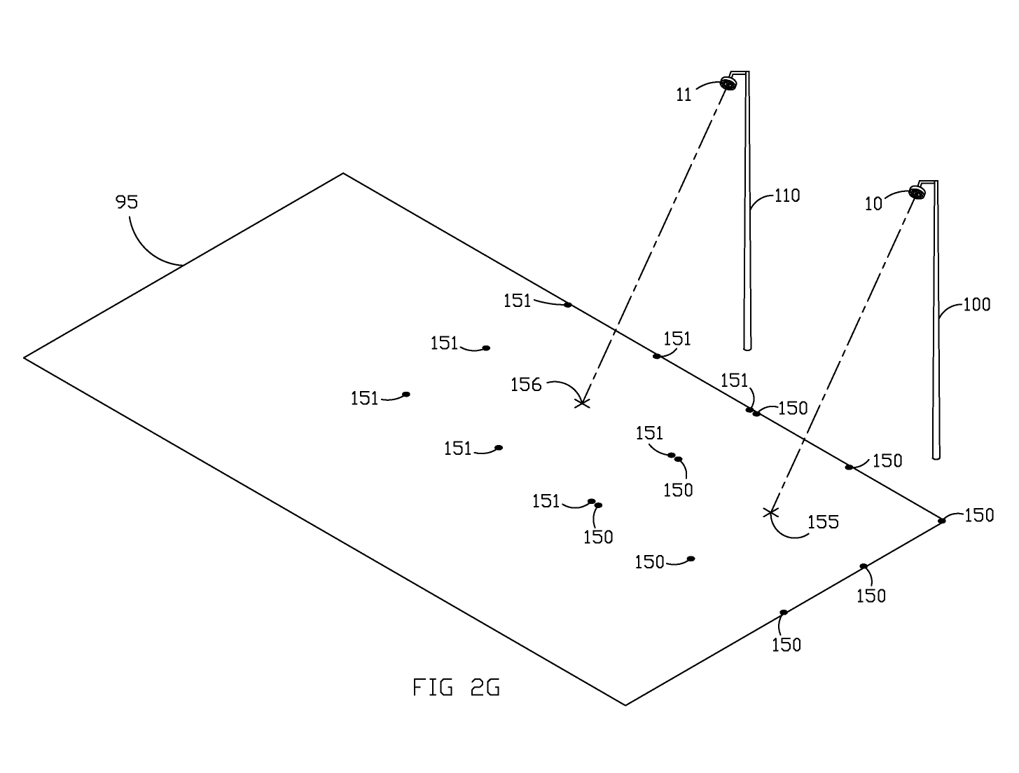

Variation on the concept of helping define aiming points or assisting in characterizing how lighting would actually apply to a given lighting task are illustrated in FIGS. 1, 2A-G, and 3A-E. Instead of utilizing some reference points with range and azimuth measurement capabilities to then record a description of aiming points or other locations at the physical target, the embodiments of FIGS. 1, 2A-G, and 3A-E utilize one or more laser beams that would project from either a demonstration location, tentative installation location, or permanent installation location for a light fixture to the actual target. Among other things, the lasers can be used to assist in several useful procedures. The procedures include, but are not limited to: visualizing how a fixture's light beam would place on the target; aiming (either from the aiming location for the fixture or from the fixture itself to the target), or helping characterize the light beam pattern on the target.

In these examples, when a light fixture is referenced, it relates to a fixture having one or more LED or solid state light sources. The LED light source can be fixed in position in the fixture or, as with any of the examples, could be individually adjustable in orientation relative its fixture. Of course, each LED source could be of a variety of different light output characteristics including beam pattern, intensity, color, etc. For purposes of illustration and not limitation, the drawings illustrate some fixtures with plural LED sources (four). Of course, it could be one, two, three, four, ten, one hundred, or even more per fixture.

Another commonality of the embodiments under the second embodiment is the use of a laser beam in association with the light fixture. The laser beam could be a single laser such as is diagrammatically illustrated at reference number 70 in FIG. 2B, such as are quite inexpensive (a few dollars) and purchasable commercially off the shelf and can provide a reasonably straight beam on the order of 500 feet. Alternatively, they can be more expensive lasers certified to be with close tolerance coaxial with their housing. The more expensive certified lasers would take less calibration than the cheaper ones in their functions with the exemplary embodiments. The lasers are mounted relative to a lighting fixture so that their beam projects in a known relationship with some attribute of the fixture (for example with the central aiming axis of the fixture or a light source of the fixture). Alternatively, they could be aimed to help visually define some aspect of a beam pattern from either the fixture compositely or individual light sources of a fixture. An example of an inexpensive laser can be found at U.S. 2006/0245189 (incorporated by reference herein) or, for example, the “Apollo VMP-1200 Laser Pointer, available from B&H Photo and Video (www.bhphotovideo.com/).

An example of LED fixtures can be found at U.S. 2009/0323330 (incorporated by reference herein).

In particular, as implied diagrammatically at FIG. 2A (an isolated diagrammatic depiction of an LED fixture), each LED source 50 could be mounted in a mount 60 on fixture 37 where the mount allows adjustability (pan and tilt) of source 50 relative to fixture 37. The adjustability can be made in a number of ways to set the central aiming axis of each source 50 in a desired direction relative to fixture 37. Alternatively, it is to be understood that a fixture 37 could be made by any of a number of well known fabrication techniques (e.g. computer numerical control metal cutters or mills), to produce receivers for the holders 60 of the sources 50 such that when the holders 60 are mounted in the receivers in fixture 37 source 50 would be precisely aimed in a predetermined direction. As can be further appreciated and with reference to the foregoing patents, the arrangement of sources 50 on fixture 37 could vary. FIG. 2A shows a radial pattern of four, another conventional arrangement would be aligning plural LEDs in one or more rows on fixture 37. Examples of adjustable LED's in fixtures are described at U.S. Pat. No. 8,356,916, incorporated by reference herein.

Another embodiment according to aspects of the invention uses multiple lasers (or other sources of collimated or highly directed light, hereafter simply “lasers”) to indicate the approximate extents of the light applied from a given lighting fixture to a given area, here area 95, FIG. 2D (e.g. athletic field, parking lot, or the like). FIG. 2E shows two light fixtures 40 and 41 which are aimed at a target area and which have 50% curves 90 and 91 touching. This situation represents a typical aiming pattern. Another aiming pattern might be 10% curves 80 and 81 touching. But in either case, the isocandela curves represent a fixed geometric relationship to the centerline of the light beam as represented by center points 75 and 76.

Laser array 10, FIG. 1, comprises several lasers 20 which can be precisely oriented angularly relative to the centerline of the fixture and radially relative to a fixed location such as a mounting point 30. Laser 25, if used, is installed coaxially with the central axis of the array. Lasers 20 and 25 can be relatively inexpensive lasers that project a highly collimated, narrow beam a substantial distance and could be mounted in a reasonably rigid, robust, and environmentally solid mount. Power could be supplied through power cables 35 which could be connected to appropriate electrical power. FIG. 2E illustrates points of laser light 150 and 151 which approximately outline the 50% curves 90 and 91. These points of light are generated by laser arrays 10 and 11 which are affixed to fixtures 40 and 41 on poles 100 and 110 respectively such that the central axis of the fixtures, as represented by points 75 and 76, are coaxial with the centerline of the laser arrays 10 and 11 as represented by laser light dots 155 and 156. This group of laser dots improves the ease with which lights may be aimed at night. There can be both the center dots 155/156 and the radial sets 150/151 projected to the target, a well as the light patterns from fixtures 40 and 41. The users can better identify the 50% or 10% curves of those beams, and their centers.

As can be seen by the diagrammatic view of the laser array 10 in FIG. 1, each laser 20 can be in a housing that either can be adjustably positioned in the overall array base 10 or, as previously suggested, the plate or base 10 can be fabricated using precisely controlled fabricating machines to form receivers for each laser 20 such that when lasers 20 are installed in the receivers, they are precisely (within reasonable tolerance) aimed in a predetermined direction from the array base or plate 10. In this manner, the number of lasers 20, and their beam directions can be predetermined for each array 10 and assembled without having to calibrate or adjust each one. As further diagrammatically illustrated in FIG. 1, a power cord 35 could be operatively connected to each laser 20/25 and connected to an appropriate source of electrical power such that can be turned on or off as needed with an appropriate switch.

FIG. 1 reference number 30 diagrammatically illustrates an attachment flange of array 10 for mounting on a light fixture. As can be appreciated, however, the attachment component could be more complex. It could be articulatable or adjustable or otherwise take a number of different forms such as are desired or appropriate for an application.

FIG. 2F represents the same situation and components as in FIG. 2E. However, the light fixtures 40 and 41 are not illuminated. Laser dots 150 and 151 represent the 50% curve location of the fixtures, assuming that laser arrays 10 and 11 have been aligned with the centerline of fixtures 40 and 41. This may be accomplished by aligning the central laser beam from the laser array with the laser beam from the fixture, or by other means such as using reference geometry.

Embodiments according to FIG. 2F therefore allow the fixtures to be aimed relative to the target area and relative to each other, without energizing the light sources, simply by aligning the laser dots as shown. Further, laser arrays 10 and 11 may be installed in a location in place of the fixtures and aimed (see FIG. 2G). Their aiming coordinates relative to their spatial coordinates may be recorded or preserved and applied to the fixtures which may be installed separately.

Light sources 40 and 41 are shown installed on separate mounting locations and poles 100 and 110, but could be installed on a common pole or mounting location. Many fixtures, either on a single mounting location or on multiple mounting locations, could be used. Laser arrays could be dedicated to a single fixture, or could be used on many fixtures by simply mounting and aligning the center lasers of the fixture with the center laser of the array. Alternatively, the mounting provisions for the laser arrays and for the light sources could be designed to sufficient precision such that installing the laser array on a fixture, or installing a laser array on the same mounting location as the intended fixture would give results that were sufficiently accurate.

A slightly different embodiment that could use the foregoing principles is illustrated at FIGS. 2A-2D. A light fixture 37 (e.g. four hi-power LEDs 50, each aimable) (FIG. 2A) has a single laser 70 mounted so as the laser beam has a known relationship to the central composite beam axis of the four LEDs of fixture 37 (FIG. 2B). Operation of laser 70 could help aim the fixture to a projected laser 75 at the target in a manner that its 50% curve 90 and/or 10% curve 80 (the intersection of the 10% intensity point 85 of the composite beam from plural LED's 58 of fixture 37 with the ground) can be applied in a desired manner to the target (FIG. 2C). Or, like FIG. 2D, a laser (70 and 71), like laser 70 of FIG. 2B, could be applied to fixtures 40 and 41 respectively to project a beam center point (75 and 76 respectively) to a target to assist in aiming fixtures 40 and 41, and their respective beam patterns (e.g. 50% and 10% curves, 90, 91 and 80, 81) for efficient illumination coverage of the target.

It can therefore be seen that each of the embodiments of FIGS. 1 and 2A-G utilizes a laser that is mounted in a correlated way with some light output characteristic of a light fixture 37, 40, 41, or alternatively is simply mounted in a position where a light fixture would be mounted for the application. The ability to project a single laser beam to some point on a target allows at least the following. First, it allows alignment of the fixture with a predetermined point on the target by communication of when the laser beam dot coincides with a predetermined point at the target. Taking from earlier examples, if it was predetermined that an aiming point 748, FIG. 7A, of a fixture was the middle tree of the trees in FIG. 7A, the fixture could be adjusted so that laser beam 70 coincides with a midpoint vertically and horizontally on the middle tree to confirm such aiming even from a long distance, tens if not hundreds of feet. This could allow aiming even in bright daylight conditions usually because utilizing sufficiently powered and collimated laser would allow a user at or near the trees to visually see the laser dot on the tree. Other methods for identifying alignment with the laser at a substantial distance away are described in U.S. 2006/0245189.

If, for example, the beam from laser 70 was calibrated to indicate the center of the beam from its fixture 37 at that particular distance from fixture 37 relative to its target, either the installer or the customer could be given a visual image, even in daylight, of where that light would strike. For pre-aiming of fixture prior to a later demonstration, it allows the fixtures to be set up and ready to go for a later nighttime demonstration.

See for example FIG. 2C. Laser 70 in fixture 37 is calibrated to fixture 37 to indicate the center of the output pattern beam from fixture 37 when elevated on pole 100. Thus a single laser beam would provide a perceivable and quite accurate visual marker of center of the beam of fixture 37. As can be appreciated by those skilled in the art, it is not always possible for the human eye to discern that center. By knowing the exact center 75, the 50% and 10% curves can be estimated, if needed, even without the light sources of fixture 37 turned on. But, of course, the composite beam 85 of the plural LED sources in fixture 37, once turned on, will produce the output pattern, in this example on the ground or horizontal surface. The center 75 of the beam, marked by laser 70, can still be important to demonstrator, installer, or customer.

One example of use of a single laser beam is illustrated in FIG. 2D. Center of beam for fixture 40 is indicated from laser 70 by its projection to spot 75. Similarly, spot 76 does the same for fixture 41 via laser 71. By any number of means and pre-known information, even without the light beams on from fixtures 40 and 41, if a person can see the center spot 75 and 76 projected on the target area, here a horizontal surface 95, knowing characteristics of the output patterns of fixtures 40 and 41 would allow the person to aim the fixtures 40 and 41 so that, for example, their 50% curves 90 and 91 just touch but their 10% curves 80 and 81 overlap as illustrated in FIG. 2D.

The more complex laser assembly 10 of FIG. 1 can be used as illustrated in FIG. 2E in a similar fashion to that of FIG. 2D. Central laser 25 from laser array 10 could be operated alone to indicate center beam 75. By knowing the output pattern of fixture 40, the user could adjust fixture 40 so that center spot 75 is at a location on target area 95 such that the 50% curve 90 for fixture 40 would closely correspond to that corner of area 95 (with the 10% curve 80 spilling slightly outside). To help know the correct position, array 10 does so by concurrently projecting from its eight lasers 20 the 50% curve 90 for fixture 40. The installer would simply call for fixture 40 to be adjusted until those laser dots 150 generally match the corner borders for area 95. No other measurements are needed. Of course, laser array 10 would be pre-manufactured to produce beams that in turn produce the 50% curve outline on area 95 from the intended placement and elevation of fixture 40 relative area 95. This can be done in a number of ways, including those that have been previously described. Array 10 would then be calibrated to have center laser 25 to accurately project to the center of the composite beam from fixture 40 (composite meaning the general center of the light output from all the LED sources 50 in fixture 40). The radial lasers 20 in array 10 would be pre-manufactured to produce an outline of the 50% curve for the composite beam 40.

FIG. 2E shows that the same arrangement for another similar fixture 41 and another similar laser array 11 could allow that fixture to be easily aimed relative to area 95 in a complementary fashion to fixture 40 and array 10. Fixture 41 would be adjusted such that the 50% curves visibly indicated on area 95 by dots 151 from laser array 11 would allow the installer to simply call for adjustment of fixture 41 until spots 151 appear as basically illustrated in FIG. 2E. This could allow quite accurate alignment of the composite beam of fixture 41 relative to that of fixture 40 for good coverage and even coverage of that portion of area 95. Of course, further additional fixtures and laser arrays could be added until comprehensive coverage of area 95 is achieved. Likewise, as would be understood by those skilled in the art, a similar aiming process could be used if aiming fixtures towards other types of targets, including but not limited to vertical structures such as houses, trees, statues and the like as illustrated in FIG. 7A. The laser dots would project to a target in a manner that corresponds to how the output pattern for the fixture would project, including, if used, the center of the composite beam.

It can be seen how the embodiments of FIGS. 1 and 2A-2G can be beneficial in the context of the present application. For example they can be beneficial for designing lighting plans by allowing a designer to aim lights with a desired overlap of isocandela curves, without the use of light meters, even during daylight hours. Thus with limited or no planning, lights can be installed that will evenly cover a target area. In effect, the installation becomes the lighting plan. Once the field has been covered by aiming according to a desired isocandela pattern, the results can be recorded and temporary lighting replaced by permanent lighting; or, the lights as installed can be left as the permanent installation. It can be beneficial for aiming fixtures according to a designing plan by allowing general aiming to be confirmed by the isocandela overlap pattern, or by simply aiming the centerline of the fixture in accordance with pre-designated locations, rather than having to use lightmeters (which can only be used at night and can be very time-consuming) or having to rely on human perception of light levels, which can be both time-consuming and inaccurate. It can be beneficial to demonstrating a lighting plan by allowing the installation of temporary or permanent fixtures in a very timely fashion, without requiring nighttime hours for initial installation. Thus a lighting plan can be conceived, installed, and demonstrated in a single day, thereby saving technician time and providing quick and reliable service to the customer. It can be beneficial to preliminarily or permanently installing lighting fixtures by reducing the time necessary to accurately install lighting fixtures. The temporary installation can be used to prove out the look that will be provided by the permanent installation, or the designer and customer can both have assurance that a lighting plan will work on installation, thereby possibly eliminating the need for a temporary installation.

### Third Embodiment

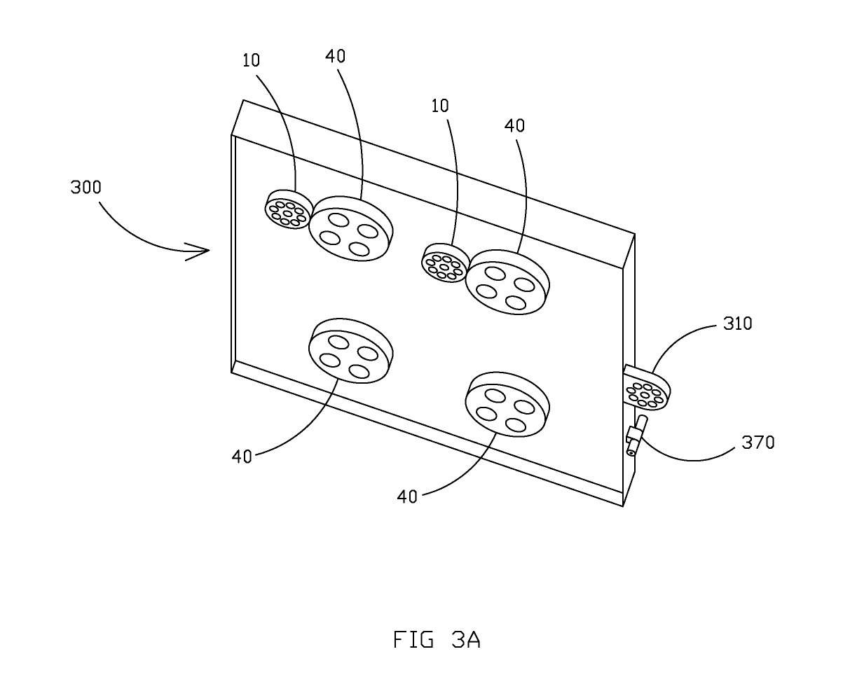

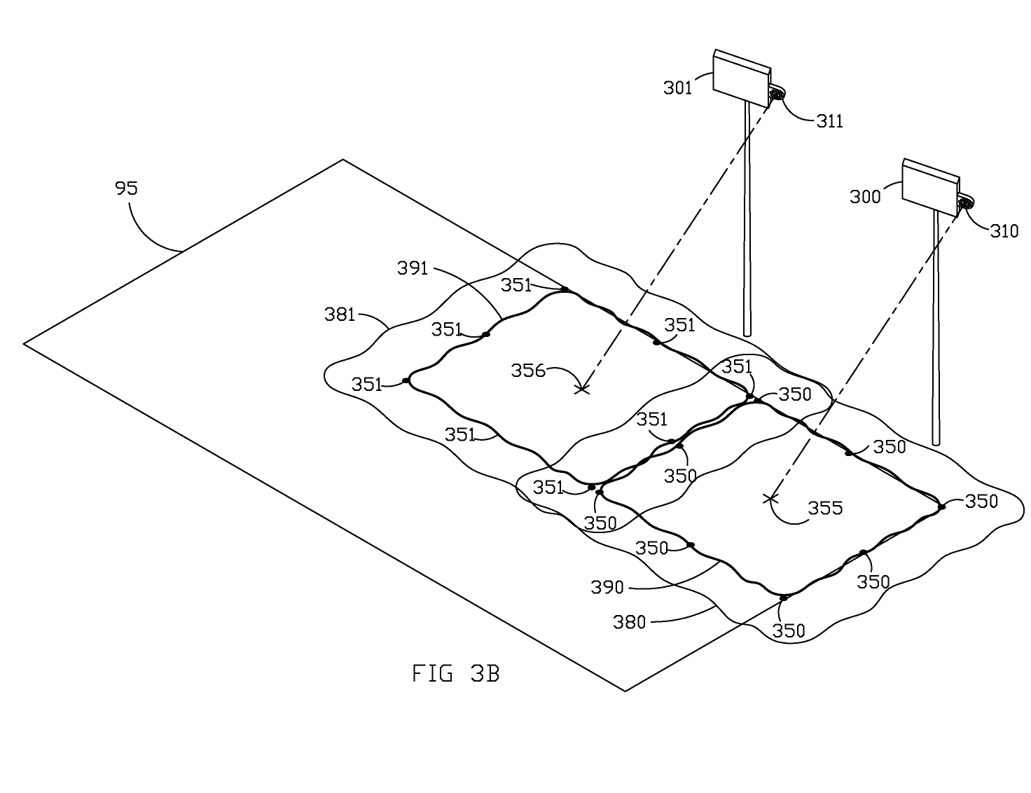

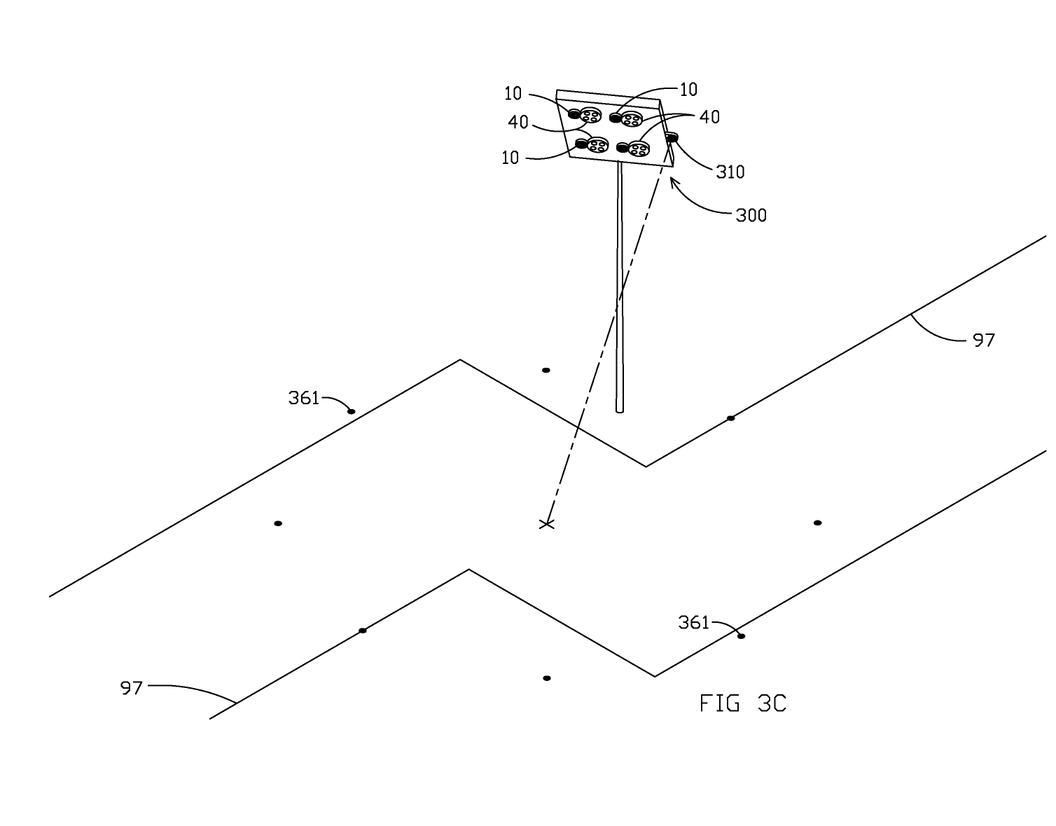

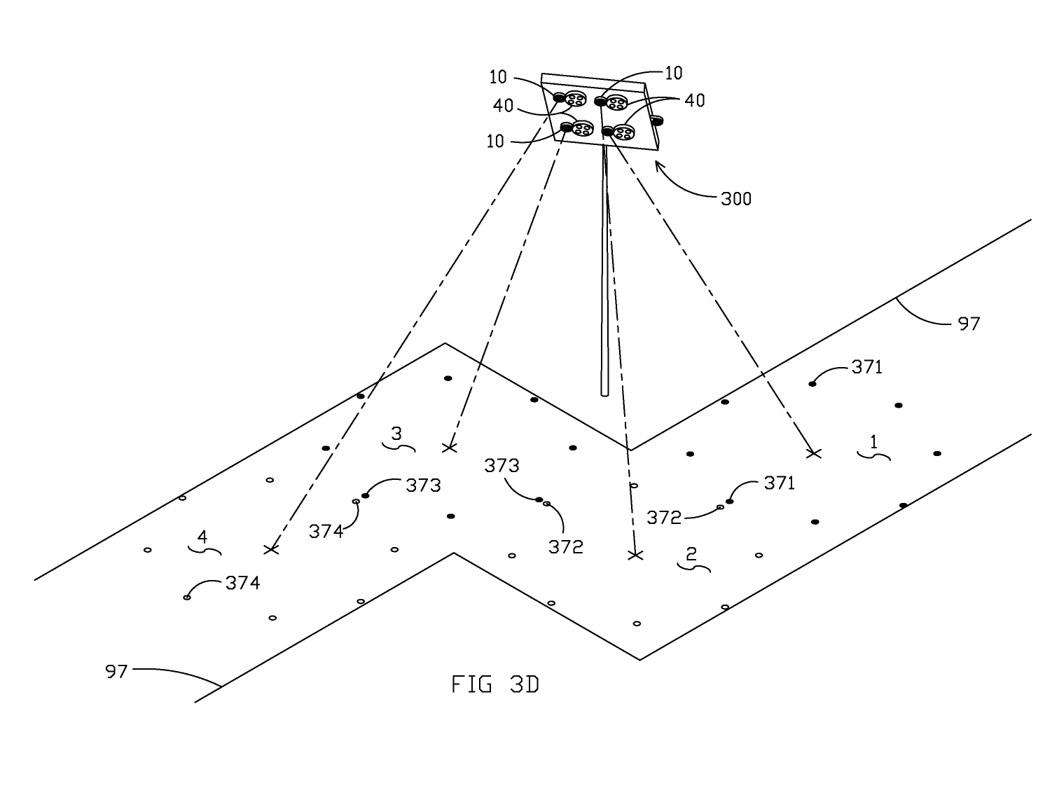

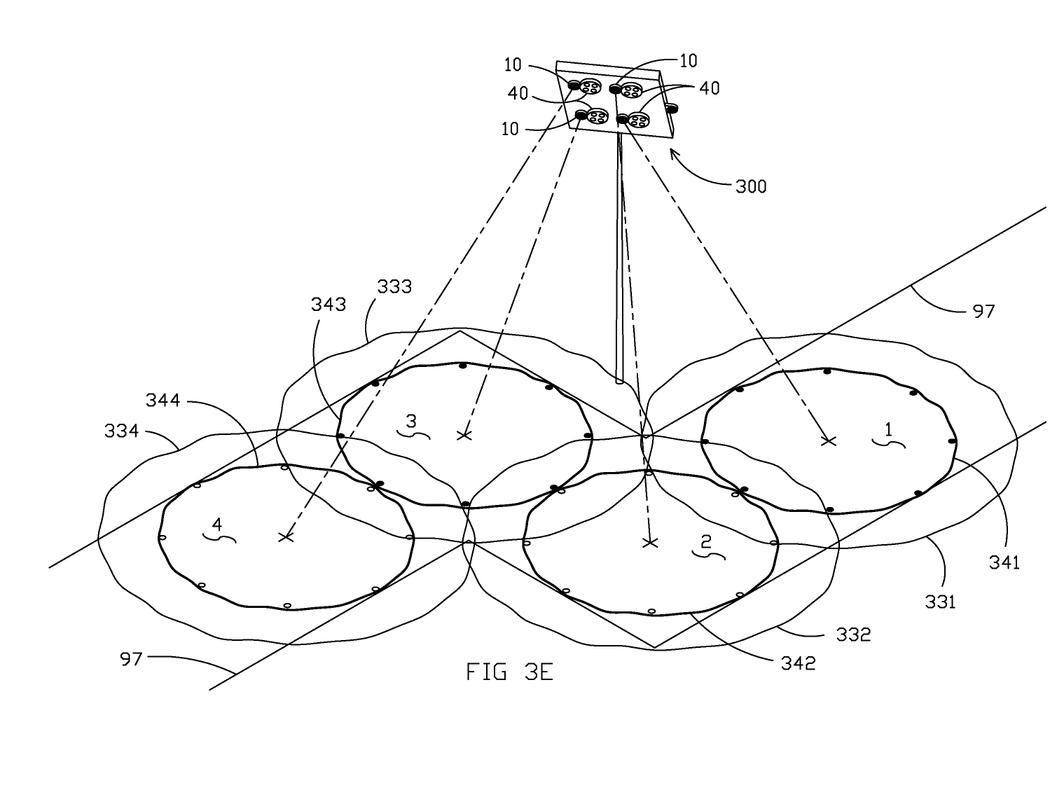

Another embodiment according to aspects of the invention uses multiple light sources 40 installed in a fixture 300, FIG. 3A. Laser arrays 10 could be installed on at least some of the light sources 40 and could be permanently or removably installed. Light sources 40 could be pre-aimed with reference to the entire fixture 300 such that the fixture would have a known beam pattern. Such beam pattern could be represented by the output from laser array 310. Aiming laser 370 could be included to allow laser array 310 to be aimed coaxially with the fixture. In this configuration, the fixture 300 would function identically to the previously described light sources 40 represented in FIG. 2D-2G. FIG. 3B shows fixtures 300 and 301 projecting 50% laser dots 350 and 351 and 10% curves 380 and 381. Laser dots 350 and 351 correspond to the 50% curves 390 and 391.

Fixtures 300 and 301 could also be installed using “fixture laser array” 310 and 311 respectively, see also array 310 in FIG. 3C, as shown, to provide initial aiming. Laser dots 361 of FIG. 3C represent a circular 50% curve representative of the composite beam pattern from the far light sources 40 of fixture 300, and could be generated from the multiple lasers in fixture laser array 310. Such a 50% curve would provide some illumination of sidewalk 97 but is not precisely matched to the sidewalk. Light sources 40, FIG. 3D could then be aimed to more accurately illuminate path 97. Laser arrays 30 may be used to individually aim light sources 40 as previously outlined. Laser dot patterns represented by laser dots 371, 372, 373, 374 correspond to the 50% curves of the individual light sources 40. This lighting effectively helps aim and illuminate areas 1, 2, 3, and 4 respectively in FIG. 3D (here a non-linear area). FIG. 3E shows the path as illuminated. The 50% curves 341, 342, 343 and 344 are evenly adjusted on the sidewalk, and the 10% curves 331, 332, 333 and 334 combine together to provide fairly even illumination over the entire area illuminated by fixture 300.

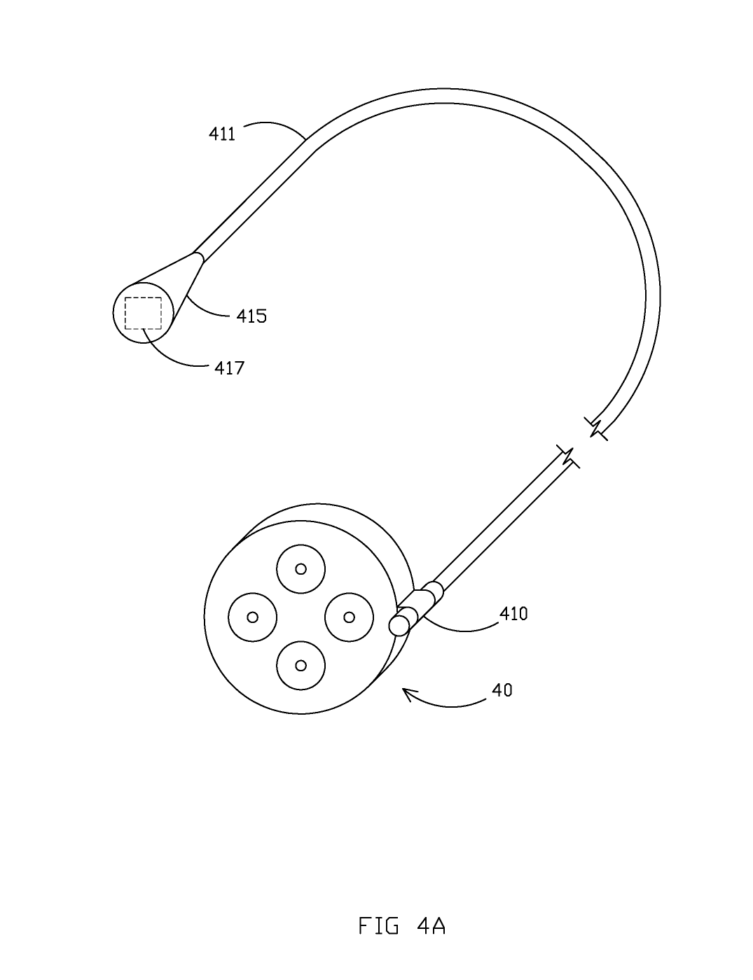

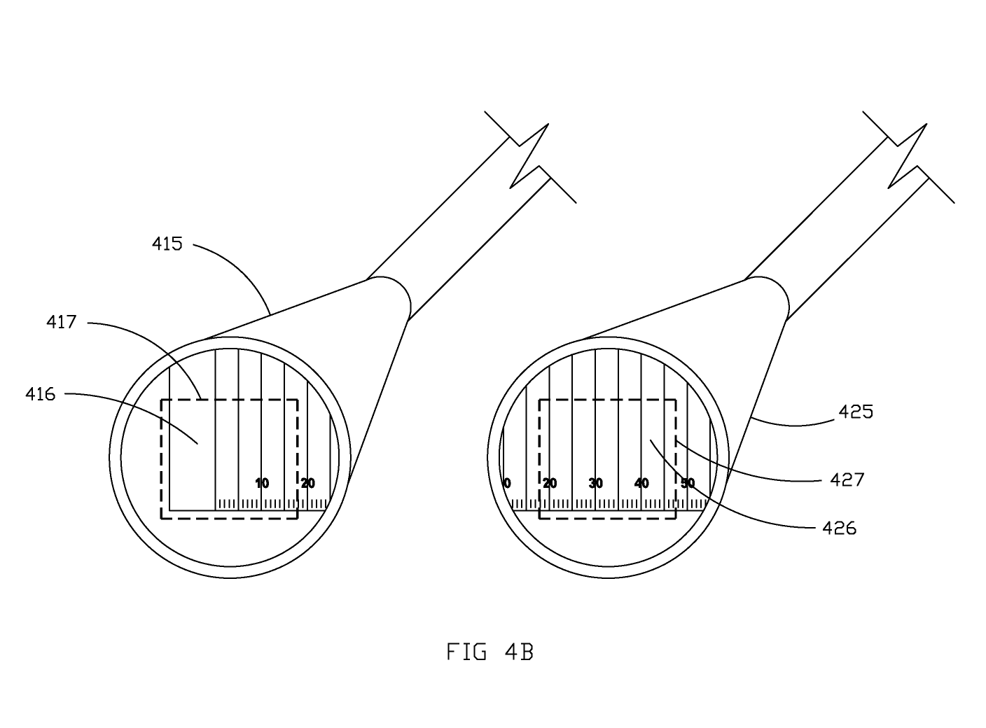

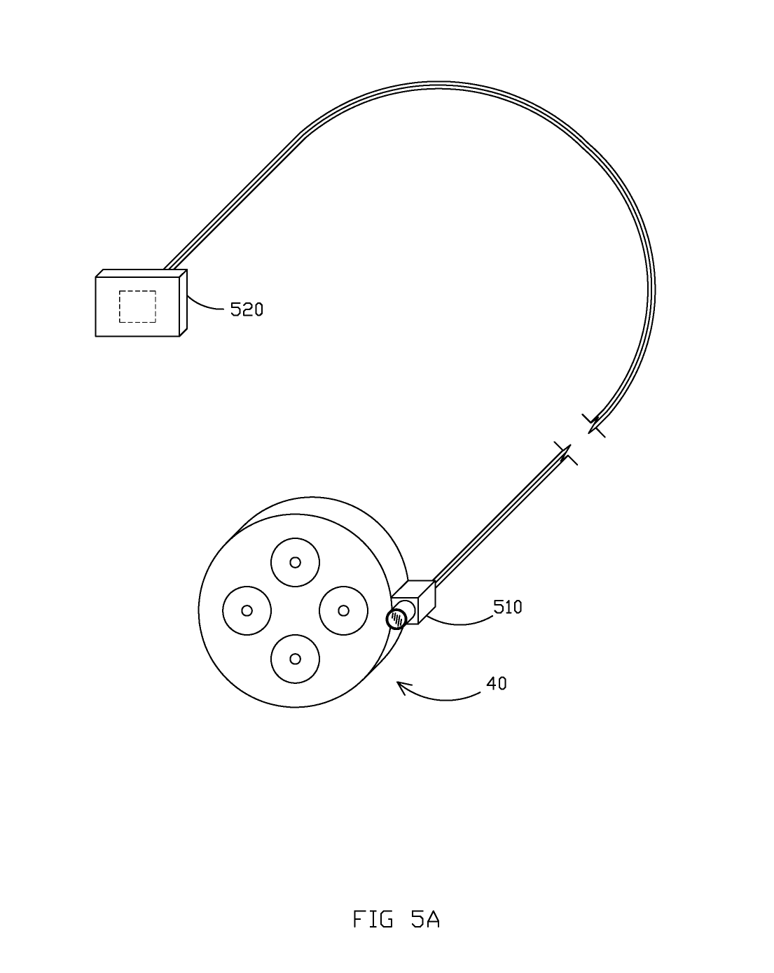

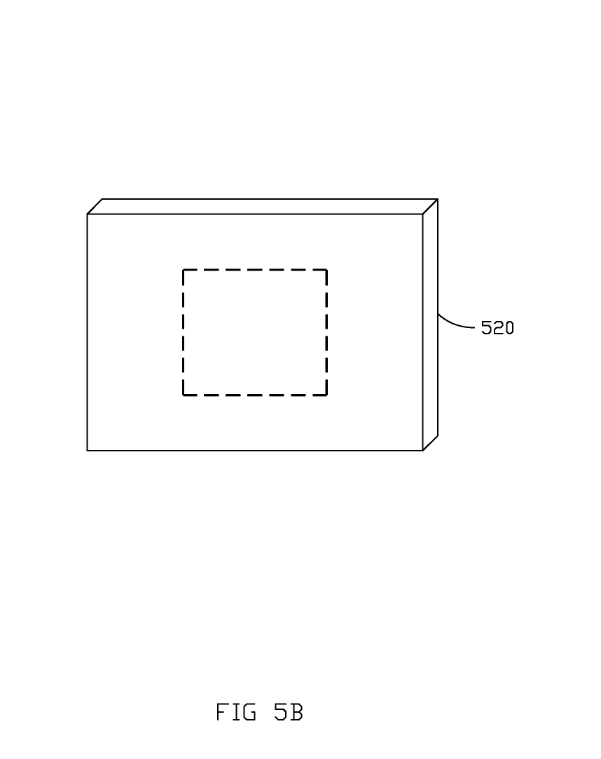

Embodiments of FIGS. 4A and B and 5A and B have similarities to the previous embodiments. By calibrating the alignment of either the lighting in 410 relative to a lighting fixture 40, e.g. aligning the field of view of sighting end 410 with basically the central aiming or beam axis of fixture 40, and then pre-manufacturing a reticule that can be placed at the eyepiece 415 and provide an express visual and proportional representation of the composite beam pattern of fixture 40, a viewer through eyepiece 415 can adjust fixture 40 and essentially move what will be the beam pattern of fixture 40 relative to the actual view of the target area until that beam pattern coincides where the designer wants it to be. The fixture can then be fixed in that orientation for operation. This can be extremely valuable when setting up the fixtures during the daytime when it would be difficult to see how the beam really relates to the target area. And, as indicated, the arrangement of FIG. 4A could be utilized with each fixture either by sequentially mounting it on each fixture as each fixture is adjusted, or, left in place in its calibrated position for each fixture so that multiple fixtures could be adjusted simultaneously (FIG. 4B). Instead of the borescope of FIGS. 4A and B, reasonably inexpensive digital cameras, with fiber optic connection to some display, or simply a camera on the fixture, could be used in a similar fashion such that essentially the analogue of a reticule, indicated at the dashed box on display 520 in FIGS. 5A-5B, could be created on the display to indicate the beam pattern that would be produced by the fixture 40. This would require that the reticule or other indicators of beam pattern be matched to the desire isocandela pattern for a given fixture. This could be easily done in some cases simply by matching the approximate field of vision angle of a particular camera model with the fixture spread. Or a fixed or adjustable reticule could be installed by the same technology used to create accurate rangefinders in cameras, duplicating the desired isocandela pattern. Or a particular camera could be calibrated to a distance and isocandela pattern of a given fixture on site, using some means of marking, even as simple as marking the isocandela pattern on the camera's LCD display. The dash line simulated reticule of FIGS. 5A and B could be applied in any number of ways including by physically marking the display screen 520 (e.g. with erasable ink, with non-erasable ink or paint, with some added template adhered, etc.). Small, relatively inexpensive digital cameras or video cameras, video cables, and small flat screen LCD-type displays are commercially available.

### Fourth Embodiment

Another embodiment according to aspects of the invention uses an apparatus which is coaxially aligned with a light source 40 to provide a view of the area which would be illuminated by a given isocandela curve from the fixture. The apparatus used in this case is similar to a flexible fiber optic borescope (commercially available, such as the Flexview VT Borescope 13552, available from Flexbar Machine Corporation, 250 Gibbs Road, Islandia, N.Y. 11749) having a sighting end 410, FIG. 4A, which is affixed to and aligned with fixture 40. Flexible shaft 411 contains an aligned array of optic fibers which allow an image from the field of view of sighting end 410 to be displayed in eyepiece 415. The area illuminated at the 50% curve is represented by reticule 417 (which can be engraved, embedded, or otherwise positioned at eyepiece 415). Thus, when light source 40 is aimed at a target location, the viewer not only sees the relevant part of the target to which the fixture is aimed, but also the reticule of the eyepiece simultaneously shows the viewer the 50% curve of the beam relative the field of view. For example, if a portion of a football field is imaged (image 416) within eyepiece 415, FIG. 4B reticule 417 shows the viewer the basic 50% beam pattern that fixture 40 will cover on that portion of the field. In this example, the 50% curve for that first fixture 40 would cover the back left corner of the end zone and out to about the eighteen yard line (and along the sideline and inwardly about a third the width of the field). When another light source 40 with its own borescope is aimed at the same football field (approximately its 50% curve), it may be aligned such that its 50% curve represented by reticule 427 is aligned next to the 50% curve of the previous light source. The viewer can see how that second beam relates to coverage of the first beam. As shown in FIG. 4B, by manual manipulation of the second fixture (or other adjustment), its aiming to the target can be adjusted until its 50% curve (beam coverage) begins at where the first beam 50% curve left off (the 15 yard line) and continue up the field, using field of view 426 and reticule 427 of the eyepiece 425 of borescope for the second fixture. This process could continue for successive fixtures to aim all of them.

### Fifth Embodiment

Another embodiment according to aspects of the invention uses a digital camera 510, FIGS. 5A and 5B, having a separate display 520, attached to a light source 40 such that the display view of the camera, or of a defined area within the viewing display of the camera, corresponds to a desired illumination curve of the fixture such as the 50% curve. Light sources would be aimed and adjusted in a similar fashion to Embodiment 3. The benefits of FIGS. 5A and 5B can be appreciated with further reference to the benefits described regarding the fourth embodiment of FIGS. 4A and B.

### Sixth Embodiment

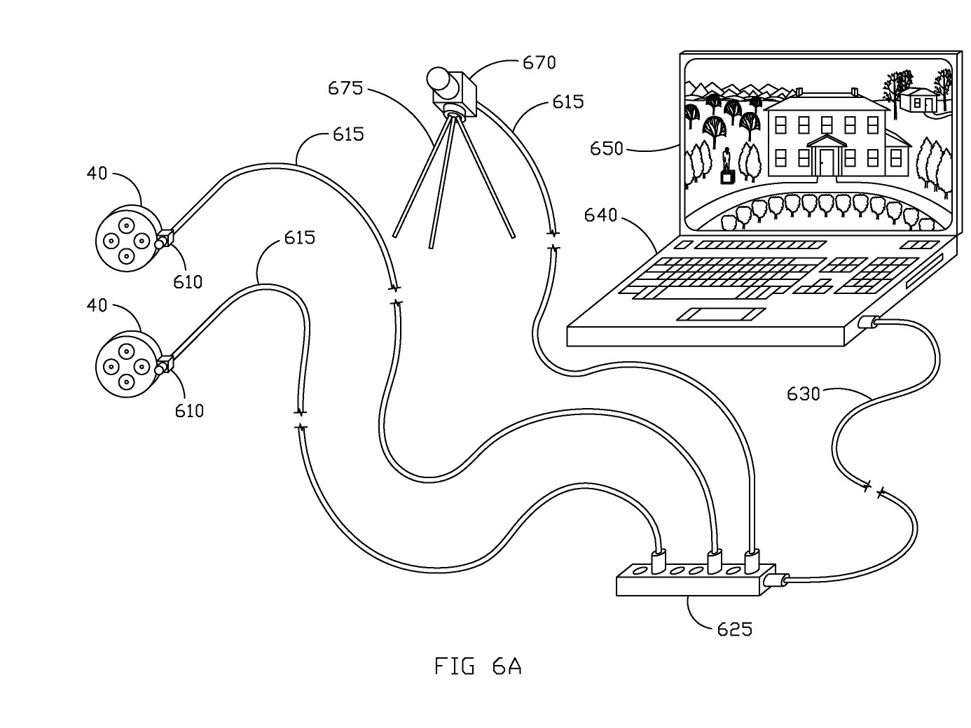

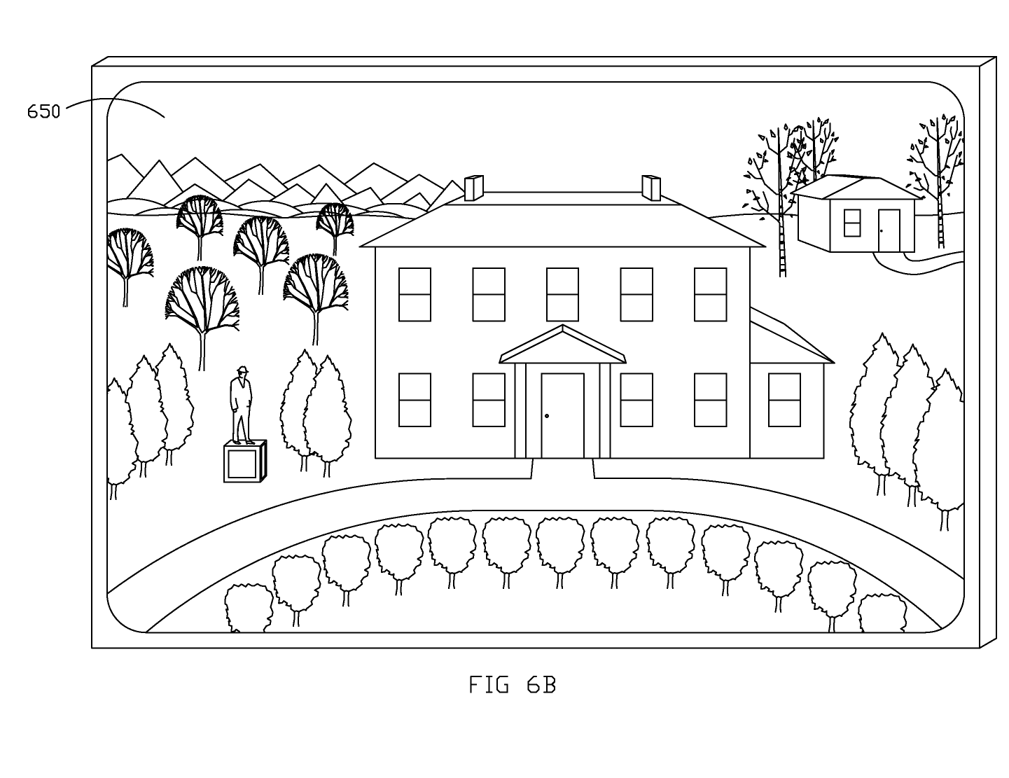

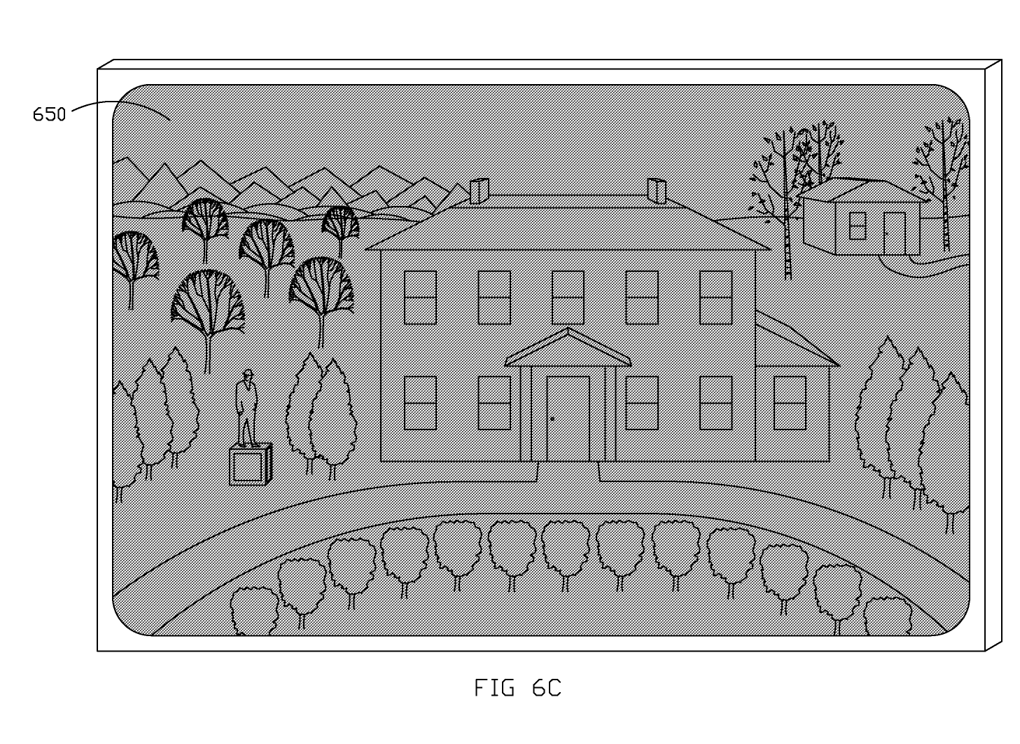

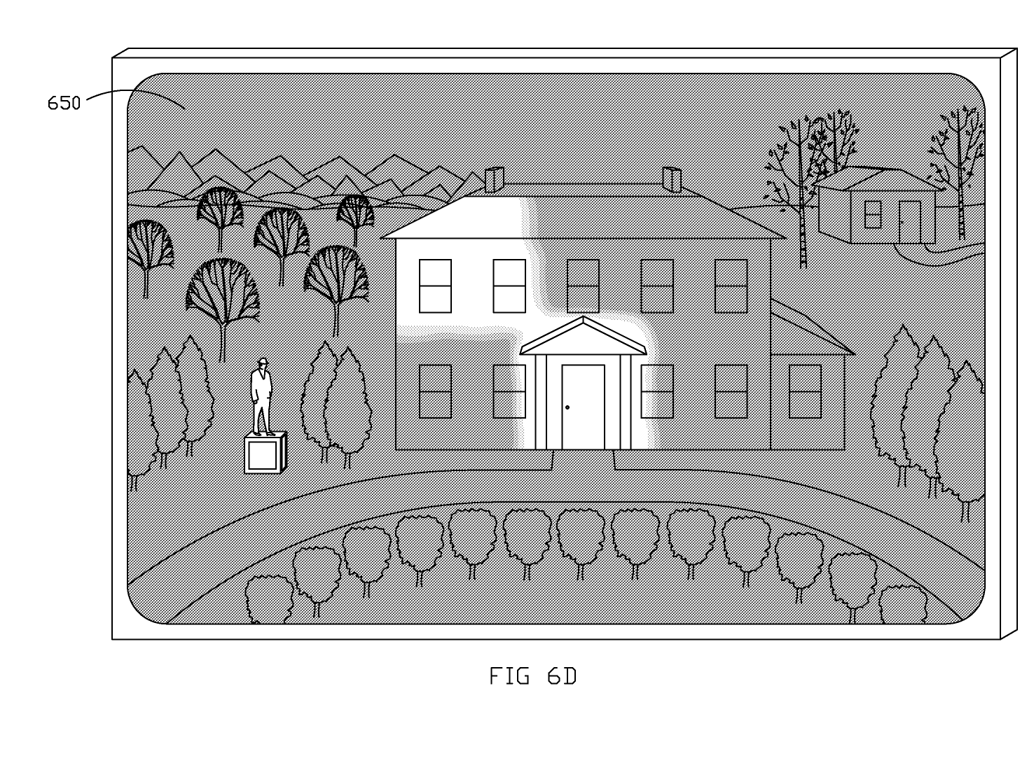

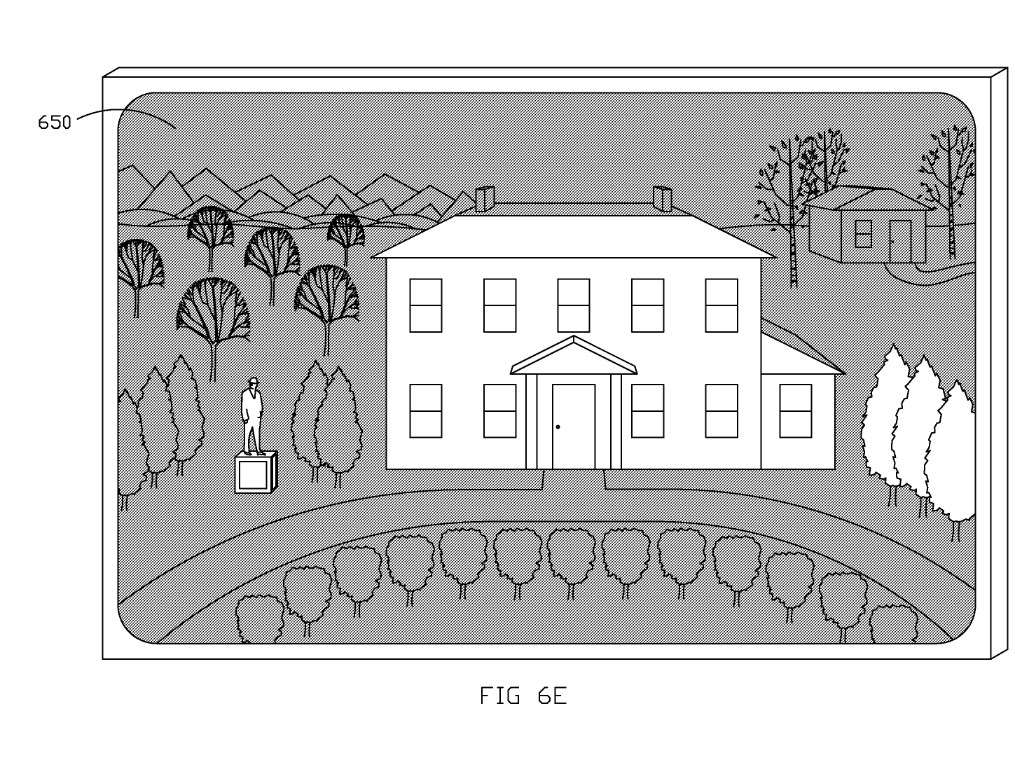

Another embodiment according to aspects of the invention uses one or more digital cameras 610, FIG. 6A, similar to embodiment five above. Each camera would be interfaced with a display device, such as a computer 640 with screen 650. Another camera 670, mounted on support 675, is interfaced to display device 640/650 (e.g. via cables 615 to a multi-port connector 625/cable 630 for plural camera inputs). In use, camera 670 is set up in a location which is documented as to geographical position (longitude, latitude, elevation, as well as camera orientation), either relative to one or more landmarks in the target area, or to an absolute GPS location. Display device 640/650 shows the target area as seen in daylight, FIG. 6B, then is darkened by mechanical or software means to simulate a night time view, FIG. 6C. A single camera 610 could be used, and transferred from one light source to another, or multiple cameras 610 could be used. As cameras 610 are aimed, their viewing area is illuminated on the display device as in FIG. 6D. Finally, as the remaining lights are aimed, the entire area will appear illuminated on the display device 640/650 as seen in FIG. 6E. This is a way to demonstrate on a computer both how the fixtures could be aimed and a simulation of what their night time illumination would look like relative to the target.

Software or hardware means could be employed to vary the displayed illumination, simulating both changes in ambient light as well as the light applied from the light sources, including brightness, color, or color temperature. Software could be developed based on calculations or camera readings to simulate additional cameras and aiming points. Site geometry could be input into computers to provide additional information for simulating and displaying illumination schemes. Software could include site measurements and parameters to allow for further manipulation and display of options and alternatives as well as to generate light levels, parts lists, and price quotes.

This embodiment would allow sophisticated pre-aiming of lighting sources during daylight hours, allowing night time demonstrations to be conducted in a few minutes rather than hours, and allowing a demonstration to lead to a firm quote for lighting. The quote would be based on, and could guarantee reproduction or provide documentation of the lighting as demonstrated.

The combination shown at FIGS. 6A-E can take on a wide variety of beneficial forms. Below are a few examples.

By any number of well known programming techniques, the system of FIG. 6A could be used beneficially to actually aim fixtures like fixtures 40 with camera 610 in an analogous way as described with FIGS. 5A and B. Camera 670, in a position that could be a known physical geographic reference position, could produce an image of the entire target area to be illuminated. Individual cameras 610, calibrated and mounted so as to coincide with the center aiming axis of their corresponding fixture 40, could have a video feed that could be switched on for computer display 650 such that its field of view would be the only one on video display 650. By utilizing the simulating reticule as described with regard to FIGS. 5A and B, the putative composite beam from the fixture 40 for that camera 610 could then be displayed to the PC operator who could adjust the fixture or instruct a co-worker to adjust the fixture to aim the fixture to a predetermined aiming point relative the target area (in manners similar to those previously described).

The next fixture with camera 610 could be aimed in a similar fashion.

Optional programmable features might be as follows:

1. The fixed overall view from camera 670 could be displayed as a fixed background on screen 650. The field of view of one or more cameras 610 could then be overlaid the base image in a manner in which somehow the more limited camera 610 field of view is independently discerned on screen 650. This would allow the person at computer 640 to see where each fixture/camera 40/610 is being aimed and instruct a desired aiming accordingly. As can be further appreciated, straight forward calculations, if the location of fixtures 40 relative to the actual target area or camera 670 is known, and there is some known relationship between camera 670 and the actual target, it may be possible to calculate or derive the angular position of fixtures 40 relative the actual target and have the computer 640 compute the same. In the reverse, it might be possible for an known lighting plan to call for a given orientation of each fixture and have the computer compute a given aiming direction of a fixture 40 to the displayed and instructed orientation and the computer user could instruct a co-worker or him/herself to adjust the fixture until those values match on the computer screen 650 as three-dimensional or two-dimensional coordinants.

FIG. 6A-E suggests many other beneficial possibilities regarding any of design, aim, demonstrate, potential illumination designs. One example is taking a digital image of the target area such as is indicated at FIGS. 6B-6E. By programming techniques and programs within the skill of those skilled in the art, a lighting designer could have a menu or inventory of virtual lighting fixtures in a toolbox on the computer. A customer or a designer could darken screen 650 in a manner to simulate nighttime for the target area. The designer or customer could then start trying different lights from the inventory. For example, a first light of a certain light output characteristic (beam width, intensity, color, etc.) could be a distinguishable icon from a light of different output characteristics on the screen or on a menu for the computer user. The user might be able to drag that icon to an aiming location and aim it to an aiming point on the virtual target. The software would automatically calculate how that light fixture would illuminate the target (see FIG. 6D), where for example two light fixtures have been selected and aimed at different aiming points (corresponding to points 741 and 745 in FIG. 7B). A computer user (whether designer, customer, or other) can then have a simulation of how that selected lighting fixture might illuminate the target. FIG. 6D also shows selection of another fixture that would illuminate the statue to the left (corresponding to aiming point 740) in FIG. 7B. Selection can continue until all aiming points or a first preliminary virtual illumination of the entire desired target (FIG. 6D) is accomplished. Of course, the software could, through conventional programming techniques, simulate the illumination on a pixel by pixel basis on display 650 according to how the chosen virtual fixtures would project light from an installation location a distance and angle to the particular surface or object being illuminated, including decrease in intensity from the center of the beam towards its periphery (towards its 50% and 10% curves for example). By conventional programming means, the computer user might even be able to place the curser across the target and the display would display numerical values for such things as intensity at that point, color, etc.

Below is an example of the basic concepts of software according to this embodiment:

### 1. Inputs

The programmer can gather information regarding a number of different lighting sources with different lighting output characteristics, including how they would illuminate surfaces at any of a range of distances away from a virtual position relative the target. Placement by dragging the fixture in the scene of the display 650 would cause the programming to calculate or select from some database data which could then simulate exactly how the light output pattern from the fixture would project on and illuminate.

The target can be a digital picture taken of the actual target or a simulated rendering. Part of the input would be to somehow characterize the target for example its surfaces (vertical, horizontal, or other), any finish on the surface (paint, color of paint or materials, shiny, matte, etc.). Depending on the software, image recognition techniques could be used to know the boundaries of objects on the target (e.g. the outline of the house, the outline of the statue, etc.).

### 2. Tools

Not only then could there be icons representing different lighting fixtures to drag into place and commence this lighting simulation, other tools are possible. Examples might be the ability to place or overlay aiming points onto the target. The aiming points could be pre-calculated or selected and then displayed so that the designer or user could know how many lights and where they should be aimed. Other overlays or additional functions or tools are, of course, possible.

And, of course, the programming could allow interchangeability of virtual fixtures. The designer or user could try one type of fixture and then try another to see quickly and effectively how the fixture might change the illumination on the target.

Finally, the software could provide information to the user that could be valuable either for preserving a record of a desired lighting plan including such things as the type of fixtures, their placement relative to the target, and the like. Alternatively, it could produce or store for later recall the lighting plan so that it could be created off-site or quickly on-site and then the lighting plan used to create an actual either temporary or permanent installation of those lighting fixtures in those locations. As described earlier, one example would be that such a virtual simulation could result in a lighting plan given to workers that could then go to the site and put up a temporary demonstration set of fixtures knowing placement, aiming to aiming points, and type of fixtures. During the demonstration, the same programming computer could be used to show the customer how different fixtures might change the illumination and might allow change over of the actual demonstration fixtures right then for the customer. Of course, such a virtual plan on the computer could also be used for installers to go out and install the permanent final version that had been planned with the software.

As can be appreciated, other functions and features of the software could be implemented.

### Options And Alternatives

The above description includes some of the many possible embodiments, and is not intended be an exhaustive description. For example: Different isocandela curves, beam types (e.g. NEMA types, hard cutoffs, etc.), numbers and types of lasers or other “dot” sources could be used. Other alignment points than centerlines could be chosen. Alignment markings or outlines could be provided by a single laser source manipulated mechanically or by mirrors or other means. A single camera might be able to interface with positioning information from the lights as aimed, given coordinates from potentiometers or other adjustment indicators. Aiming and illumination displays could be transmitted over the internet for live, remote demonstrations. And many other options and alternatives are envisioned.

As will be appreciated by those skilled in the art, variations to the embodiments described above are possible and included within the invention, which is not limited by the described embodiments.

What is claimed is:

1. A method of designing an aiming scheme for plural lighting fixtures to illuminate a target space situated in real three dimensional physical space definable by a three-dimensional physical space coordinate system comprising:
a. establishing a physical space reference location in the physical space;
b. designating a plurality of physical space aiming points associated with illumination locations in the physical space;
c. describing the positional relationship of the plurality of physical space aiming points in the three-dimensional physical space coordinate system relative the physical reference location;
d. recording the positional relationships in physical space with identifying information about the physical space aiming point in a memory device;
e. recalling at any time the positional relationships in physical space from the memory device;
f. designating light fixture locations relative to the physical space;
g. calculating offset of each of the light fixture locations from the physical reference location in the three-dimensional physical space coordinate system; and
h. translating aiming directions from the light fixtures locations to the physical space aiming points taking into account the calculated offset;
i. so that a point-by-point aiming plan for the target space can be created correlated to designated physical space aiming points and can be reproduced at any time and plural times.

2. The method of claim 1 wherein the reference location comprises a geographic location and elevation based on GPS, surveying, or landmark, and by distance and angle from reference location, or distance from multiple landmarks, and correlated to the geographic location of the target space.

3. The method of claim 1 wherein the aiming points comprise calculated or translated geographic locations and elevations relative to the reference location.

4. The method of claim 1 wherein the aiming points comprise word descriptions of location of an aiming point relative one or more objects in the target space.

5. The method of claim 1 further comprising adding lighting and illumination criteria correlated to each aiming point.

6. The method of claim 5 wherein the lighting and illumination criteria can include one or more of:
a. intensity;
b. color;
c. color temperature;
d. subjective aesthetic characteristics;
e. luminance readings;
f. observations; and
g. computer-generated characteristics.

7. The method of claim 1 wherein the light fixtures comprise one or more light sources.

8. The method of claim 8 wherein the light fixtures each comprise plural LED light sources.

9. The method of claim 9 wherein each LED light source is independently aimable.

10. The method of claim 1 further comprising capturing an image of the target space.

11. The method of claim 1 wherein a laser is utilized to site to aiming locations from the reference location.

12. The method of claim 1 further comprising adding type and number of light fixtures to the point-by-point aiming plan and setting up real light fixtures at the light fixture locations in physical space, wherein each light fixture is mounted on an elevating structure and can be independently panned or tilted relative to the target space and its elevating structure based on the point-by-point aiming plan.

13. The method of claim 1 wherein the translation of aiming directions of each light fixture comprises calculating a pan and tilt orientation relative to a physical space aiming point and adjusting the real light fixtures accordingly.

14. The method of claim 13 wherein the adjusting of the real light fixtures is with assistance such as transits, GPS, survey equipment, laser beams, or the like.

15. The method of claim 13 wherein the light fixture has an aiming axis correlated with a light output generated from the light fixture, a laser device is mounted on the lighting fixture to project its beam coincident with the lighting fixture aiming axis and the adjusting of the real light fixtures comprises adjusting the light fixture until its laser beam projects onto a desired aiming point in physical space based on the point-by-point aiming plan.

16. The method of claim 15 wherein the laser beam is of sufficient intensity and color that its projection onto an object in physical space can be detected by the human eye even in bright daylight although the trajectory of the beam through air cannot be seen.

17. The method of claim 1 further comprising recording an image of the target space, correlating the reference position and aiming points to identifying information related to objects in the image, and recording the correlations in the memory device so that a reproduction of the image allows re-correlation of aiming points to objects in the image.

18. The method of claim 17 wherein the image is reproduced on a display at a location remote from the physical target space.

19. The method of claim 18 further comprising simulating placement of light fixtures in the image, calculating offset of each of the simulated light fixtures from the reference location in a three-dimensional image space coordinate system, and simulating illumination by the simulated light fixtures to the aiming points in image space for viewing on the display.

20. The method of claim 19 further comprising adjusting the simulated illumination to provide viewers different simulating lighting schemes on the display.

21. The method of claim 19 further comprising communicating the display of simulated illumination to another display at a third location also remote from the physical target space.

22. The method of claim 13 wherein the adjustment of aiming directions is conducted relative to the elevating structure by utilizing the pre-calculated pan and tilt orientations.

23. The method of claim 22 wherein the adjustment of aiming directions is conducted in daylight in preparation for demonstration of illumination from the lighting fixtures on the target space at night.

24. The method of claim 1 the step of describing positional relationship in the three-dimensional physical space utilizes at least one of:
a. a laser beam between the reference location and each aiming point;
b. a surveying apparatus,
c. a digital camera.

25. The method of claim 1 further comprising demonstrating illumination of the target space with aiming of the light fixtures correlated to the aiming points.

26. The method of claim 1 further comprising obtaining an optical view of the target space through an optical device, the optical view defining an optical space having a three-dimensional optical space coordinate system;

27. An apparatus useful in designing or demonstrating lighting systems and schemes for a target space having one or more landmarks or objects in the target space comprising:
a. a portable digital device;
b. a user interface associated with the digital device which allows user-entry of data;
c. a display associated with the digital device;
d. a digital memory associated with the digital device in which is stored a description of each of plural aiming points relative to the target space or landmarks or objects in the target space and a description of at least one reference location relative to the target space;
e. so that at any time and once or plural times data associating the plural aiming points with the reference location can be recalled for review or further use.

28. A system useful in aiming or demonstrating direction and light output distribution patterns from a light fixture relative a target area comprising:
a. a light fixture having a light fixture aiming axis, one or more light sources which produce a fixture light output distribution pattern, and pan and tilt adjustment;
b. a light aiming module mounted relative to the light fixture which has a known relationship to the aiming axis of the light fixture and which can provide a visually perceivable indication of an aiming point or set of points relative to the target area;
c. so that operation of light aiming module provides confirmation of desired pan and tilt adjustment of the light fixture relative to the target area.

29. The system of claim 27 wherein each light source in the light fixture is independently adjustable relative to the fixture.

30. The system of claim 27 wherein the lighting aiming module comprises a laser which emits a laser beam along a laser beam aiming axis.

31. The system of claim 27 wherein the light aiming module comprises a plurality of lasers positioned concentrically to project a set of laser beams to produce a visually perceivable generally circular or oblong outline at the target area.

32. The system of claim 29 wherein the circular or oblong outline is correlated with isocandela curve of the output distribution pattern of the fixture.

33. The system of claim 30 wherein the isocandela curve simulated by the circular or oblong outline corresponds to one or:
a. 75% intensity;
b. 50% intensity;
c. 10% intensity;
d. no perceivable intensity; or
e. other percentage intensity.

34. The system of claim 27 wherein the lighting aiming module comprises an optical device.

35. The system of claim 33 wherein the optical devices has an imaging end mounted on the fixture and a viewing end in optical communication with the imaging end.

36. The system of claim 34 wherein the viewing end has superposed on it indicia indicating one or more of:
a. a scale representation of one or more isocandela curves for a given light source, lights sources, or fixture;
b. a target area or portion thereof;
c. one or more aiming points.

37. The system of claim 34 wherein the optical device comprises a borescope, wherein the imaging end is a borescope sighting end and the viewing end is a borescope eyepiece and the indicia is a substitute reticule.

38. The system of claim 33 wherein the optical device comprises a camera system, wherein the imaging end comprises a digital camera or digital imager and the viewing end comprises a digital display, and the indicia are superposed onto the displayed image from the camera.

39. The system of claim 27 comprising a camera system for each of a plurality of fixtures, a reference camera associated with a reference position, all in operative communication with a computer and computer display to display any image of any camera or combinations or superposed images of plural cameras on the computer display.

40. The system of claim 38 further comprising software on the computer which includes one or more of the following functions:
a. display of an image of the target area or a portion thereof;
b. superposing of indicia over the target area image;
c. simulation of ambient and added illumination relative the image of the target;
d. simulation of specific light output distribution patterns from one or more light sources relative to aiming points associated with the target area.

41. The system of claim 27 wherein plurality of light sources of the fixture are organized into a plurality of light modules.

42. The system of claim 31 wherein each light module includes a said lighting aiming module, so that the aiming direction or output pattern of each light module can be estimated by laser projections from each light aiming module.

43. The system of claim 32 wherein the light aiming module of the fixture is adapted to project aiming direction or output pattern of the fixture, and the light aiming modules of each light module independently project aiming direction or output pattern of each light module on the fixture.

44. The system of claim 27 wherein the visually perceivable indicia at the target can be aligned with one or more of:
a. a predetermined aiming point relative to the target area;
b. a selected aiming point at the target;
c. a pan and tilt direction for the fixture from a lighting plan for the target area.

45. The system of claim 27 further comprising a computer having memory to record data, the data comprising one or more of:
a. pan and tilt adjustments for a fixture, a light source, or plural light sources;
b. descriptive characterizations of aiming points associated with the target area;
c. azimuth and elevation values for a fixture, a light source, or plural light sources.
